(19) United States
(12) Patent Application Publication
(10) Pub. No.: US 2025/0310064 A1
(43) Pub. Date: Oct. 2, 2025

(54) NOMINAL CSI-RS CONFIGURATIONS FOR SPATIAL BEAM PREDICTION

(71) Applicant: QUALCOMM Incorporated, San Diego, CA (US)

(72) Inventors: Qiaoyu LI, Beijing (CN); Hamed PEZESHKI, San Diego, CA (US); Mahmoud TAHERZADEH BOROUJENI, San Diego, CA (US); Tao LUO, San Diego, CA (US)

(21) Appl. No.: 18/881,210

(22) PCT Filed: Aug. 11, 2022
(86) PCT No.: PCT/CN2022/111775

§ 371 Date: Jan. 3, 2025

(51) Int. Cl. H04L 5/00; H04B 7/06

(52) U.S. Cl. CPC H04L 5/0057; H04B 7/06952

(57) ABSTRACT

Aspects are provided which allow a UE to be configured with nominal CSI resources which provide virtual references for the UE to report channel information for one set of predicted transmission beams (e.g., Set A beams) based on measurement results of another set of physical transmission beams (e.g., Set B beams). The UE may initially receive a configuration of a reference signal resource for a virtual reference signal that does not occupy a physical resource. The UE may subsequently transmit a report indicating channel information associated with the reference signal resource. As a result, beam management operations based on AI/ML-based beam prediction or selection may be improved over conventional beam prediction approaches, since the nominal CSI-RS resource configurations allow the UE to measure signals in less transmission beams, to switch between fewer reception beams in determining a best beam pair, and to receive less physical reference signals in wireless communication.

### BACKGROUND

### Technical Field

The present disclosure generally relates to communication systems, and more particularly, to a wireless communication system between a user equipment (UE) and a base station.

### Introduction

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication are provided. The apparatus may be a UE. The UE includes a processor, memory coupled with the processor, and instructions stored in the memory and operable, when executed by the processor, to cause the apparatus to receive a configuration of a reference signal resource for a virtual reference signal that does not occupy a physical resource, and transmit a report indicating channel information associated with the reference signal resource.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of DL channels within a subframe, in accordance with various aspects of the present disclosure.

FIG. 2C is a diagram illustrating an example of a second frame, in accordance with various aspects of the present disclosure.

FIG. 2D is a diagram illustrating an example of UL channels within a subframe, in accordance with various aspects of the present disclosure.

FIG. 3 is a diagram illustrating an example of a base station and user equipment (UE) in an access network.

FIG. 4 illustrates an example of beam management operations typically associated with 5G (NR) networks.

FIG. 5 illustrates an example of spatial domain (SD) and time domain (TD) based beam prediction or selection at the base station or the UE using an artificial intelligence (AI)/machine learning (ML) model.

FIG. 6 illustrates an example of channel state information reference signal (CSI-RS) patterns that may be configured in respective resource blocks for non-zero power (NZP) CSI-RS or zero power (ZP) CSI-RS.

FIG. 7 illustrates an example of UE-based beam prediction in the spatial domain or in the spatial and temporal domain.

FIGS. 8A and 8B illustrate examples of nominal CSI-RS resource configurations.

FIGS. 9A and 9B illustrate examples of other nominal CSI-RS resource configurations.

FIG. 10 illustrates an example of a time domain pattern configuration for a nominal CSI-RS resource.

FIG. 11 illustrates an example of another time domain pattern configuration for a nominal CSI-RS resource.

FIGS. 12A-12B illustrate examples of CSI-RS pattern configurations for a nominal CSI-RS resource.

FIG. 13 illustrates an example of beam information for a nominal CSI-RS resource.

FIG. 14 illustrates an example of UE capability information indicating a maximum number of configurable or active nominal CSI-RS resources or ports.

FIG. 15 is a diagram illustrating an example of a call flow between a UE and a base station.

FIG. 16 is a flowchart of a method of wireless communication at a UE.

FIG. 17 is a diagram illustrating an example of a hardware implementation for an example apparatus.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

5G NR (New Radio) supports very high data rates with lower latency in sub-6 GHz and mmW frequency bands compared to LTE (4G) technology. Due to the propagation loss and other losses associated with the very high frequencies of mmW bands, directional communication is generally applied at such frequencies using antenna arrays with large numbers of antenna elements. As these directional links require accurate alignment of transmitted and received beams, beam pair alignment and other beam management operations have been introduced in 5G NR. Such beam management operations may include, for example, beam sweeping (e.g., covering a spatial area with a set of beams according to pre-specified intervals and directions), beam measurement (e.g., evaluation of the quality of a received signal based on metrics such as reference signal receive power (RSRP) or signal to interference and noise ratio (SINR)), beam determination (e.g., selection of one or more suitable or best beams according to the beam measurements), and beam reporting (e.g., reporting beam quality and beam decision information to the base station). Beam management may thus allow UEs that are not in connection with a base station (e.g., in an idle mode or during initial access), and UEs that are in connection with the base station (e.g., in a connected mode, during tracking, or otherwise when the UE is exchanging data with the network), to acquire and maintain a set of transmission and reception beams to be used for uplink and downlink communications, respectively.

UEs and base stations are also moving towards applying artificial intelligence (AI) or machine learning (ML) for beam management in target use cases for improving performance or reducing complexity of beam management operations. One such target use case in beam management is beam prediction in the time and/or spatial domain, where a base station or UE may utilize an AI/ML model to predict suitable or best beams based on previous beam measurements to reduce overhead and latency and improve accuracy in beam determination or selection. This use case may involve training, deploying, monitoring, and updating the AI/ML model to improve inferences or predictions of best beams for downlink or uplink communications.

To allow the base station to improve beam management operations based on AI/ML-based beam prediction or selection, the UE may intend to report to the base station predicted L1-RSRP(s)/L1-SINR(s) of one set of transmission beams (e.g., Set A beams) based on measurement results (e.g., L1-RSRPs or L1-SINRs) of another set of transmission beams (e.g., Set B beams). Set B beams may be a subset of Set A beams or may be otherwise different than Set A beams. For example, Set A beams may include narrow beams, while Set B beams may include wide beams, although Set A beams and Set B beams can be different than narrow-wide in other examples. Regardless of how Set A beams or Set B beams are defined, a main difference between these two sets of beams is that while Set B beams carry physical reference signals (e.g., SSBs or CSI-RS), Set A beams may not carry any physical information (e.g., these predicted/selected beams may not actually be transmitted by the base station or received by the UE). In other words, Set A beams may be considered to carry virtual reference signals, or more practically, virtual CSI-RS (since Set A beams are generally narrow beams which would not be as conducive for virtual SSBs).

However, conventional CSI-RS configurations which the UE typically applies for L1-RSRP/L1-SINR reporting, assume that respectively indicated CSI-RSs are physical reference signals that are actually transmitted (e.g., by a serving cell or a neighboring non-serving cell). Thus, while current CSI-RS definitions exist for physical reference signals in Set B beams, no CSI-RS definitions or resource configurations currently exist for virtual (or “nominal”) reference signals in Set A beams. Therefore, as this lack of definition for nominal CSI-RS resources may cause ambiguity in CSI reporting for such resources, it would be helpful to introduce a configuration mechanism for nominal CSI-RS resources associated with target beams (e.g., Set A beams) to better support beam prediction in the spatial domain or the spatial and temporal domain. Likewise, it would be helpful to allow the UE to identify appropriate CSI-RS patterns and beam shape information for such nominal CSI-RS resources to better support prediction of such resources' CSI. Furthermore, since the UE hardware or software that may be required to process nominal CSI-RS resources and ports may be different than those required for processing physical CSI-RS resources and ports, it would further be helpful to provide additional UE capability signaling for the UE to indicate its supported, maximum number of configured or active nominal CSI-RS resources or ports.

To these ends, a UE may be configured, activated, or triggered with a number of nominal CSI-RS resources. These nominal CSI-RS resources may be pre-configured, or configured by a base station, with multiple rules that distinguish these resources from conventional, physical CSI-RS resources. For instance, in one rule, the UE may not expect to receive or measure nominal CSI-RS resources. That is, nominal CSI-RS resources do not occupy physical resources in the time domain, frequency domain, or code domain (e.g., as in Set A beams). Moreover, in another rule, the UE may expect to report at least a CRI and/or a signal quality metric (e.g., L1-RSRP or L1-SINR) associated with a nominal CSI-RS resource. In one example, the UE may identify L1-RSRPs/L1-SINRs of nominal CSI-RS resources based on SSB measurements of physical SSBs (e.g., in Set B beams). In another example, the base station or network may configure the UE with an AI/ML model in which the UE may input L1-RSRPs/L1-SINRs measured from such SSBs (e.g., in Set B beams), where the output of the AI/ML model includes L1-RSRPs/L1-SINRs associated with such nominal CSI-RS resources. Based on the AI/ML model output, the UE may identify the signal quality metric(s) to be reported for those nominal CSI-RS resources.

Thus, similar to physical CSI-RS resources, nominal CSI-RS resources may provide a manner for indexing or identifying virtual reference signals so that the UE may determine which resource refers to which transmission beam in Set A beams, and so that the UE may report signal quality metrics for these virtual reference signals accordingly. For example, currently a UE may be configured with 8 physical CSI-RS resources (or other number of resources) in different transmission beams, which associated CSI-RSs the UE may measure, and the UE may report a single CRI for one of the measured beams (e.g., one of the CRI #s 1-8 corresponding to a best beam) and the L1-RSRP/L1-SINR associated with that physical CSI-RS resource. Similarly here, the UE may be configured with nominal CSI-RS resources associated with different transmission beams and CRIs associated with virtual reference signals (which are not transmitted), and the UE may similarly report CRI for one of the predicted beams and/or the L1-RSRP/L1-SINR associated with that nominal CSI-RS resource. As an example, rather than the UE being configured to receive eight physical CSI-RS #1-8 as previously noted, here the UE may be configured with four physical CSI-RS resources with CRI #s 1, 3, 5, 7 (corresponding to the set B beams) and four nominal CSI-RS resources with CRI #s 2, 4, 6, 8 (corresponding to the set A beams), and the UE may predict and report one of nominal CRI #s 2, 4, 6, 8 (e.g., the best beam or prediction result) based on a measurement result of one of the physical CRI #s 1, 3, 5, 7. The nominal CSI resources may thus provide references for the UE to report one or more predicted/selected set A beams based on one or more received/measured set B beams. As a result, in contrast to conventional beam prediction approaches, here the nominal CSI-RS resource configurations allow the UE to measure signals in less transmission beams, to switch between fewer reception beams in determining a best beam pair, and to receive less physical reference signals in wireless communication, thereby allowing the UE to save power consumption, experience reduced latency, and communicate with reduced overhead.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

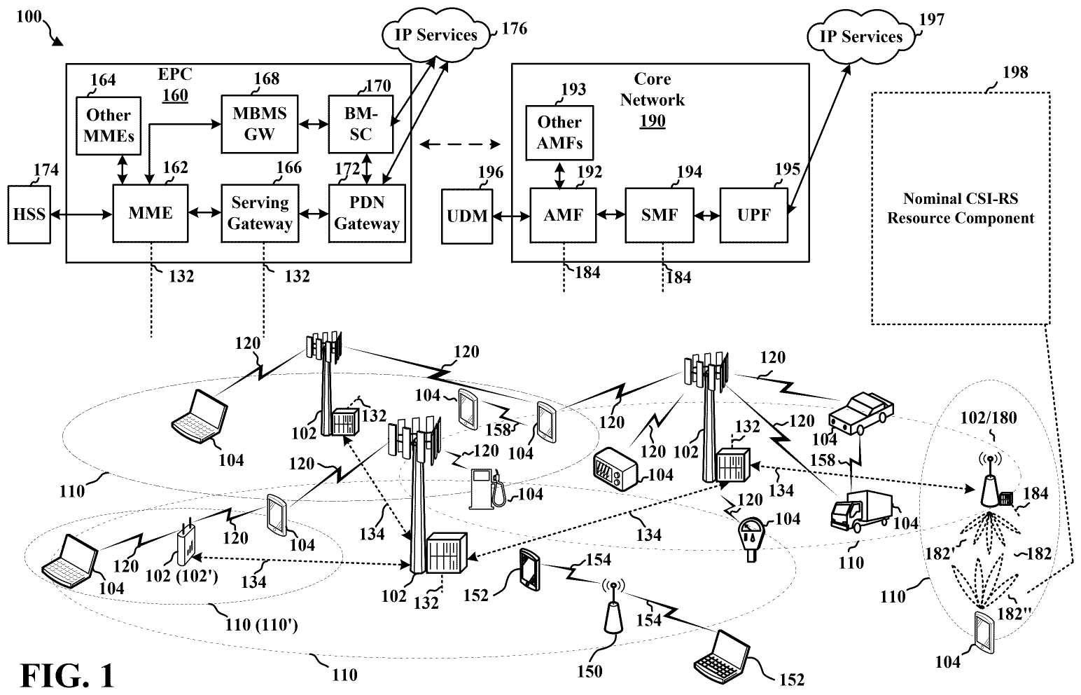

FIG. 1 is a diagram illustrating an example of a wireless communications system and an access network 100. The wireless communications system (also referred to as a wireless wide area network (WWAN)) includes base stations 102, user equipment(s) (UE) 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G Long Term Evolution (LTE) (collectively referred to as Evolved Universal Mobile Telecommunications System (UMTS) Terrestrial Radio Access Network (E-UTRAN)) may interface with the EPC 160 through first backhaul links 132 (e.g., S1 interface). The base stations 102 configured for 5G New Radio (NR) (collectively referred to as Next Generation RAN (NG-RAN)) may interface with core network 190 through second backhaul links 184. In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, Multimedia Broadcast Multicast Service (MBMS), subscriber and equipment trace, RAN information management (RIM), paging, positioning, and delivery of warning messages. The base stations 102 may communicate directly or indirectly (e.g., through the EPC 160 or core network 190) with each other over third backhaul links 134 (e.g., X2 interface). The first backhaul links 132, the second backhaul links 184, and the third backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y megahertz (MHz) (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, WiMedia, Bluetooth, ZigBee, Wi-Fi based on the Institute of Electrical and Electronics Engineers (IEEE) 802.11 standard, LTE, or NR.

The wireless communications system may further include a Wi-Fi access point (AP) 150 in communication with Wi-Fi stations (STAs) 152 via communication links 154, e.g., in a 5 gigahertz (GHz) unlicensed frequency spectrum or the like. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same unlicensed frequency spectrum (e.g., 5 GHz, or the like) as used by the Wi-Fi AP 150. The small cell 102′, employing NR in an unlicensed frequency spectrum, may boost coverage to and/or increase capacity of the access network.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band.

A base station 102, whether a small cell 102′ or a large cell (e.g., macro base station), may include and/or be referred to as an eNB, gNodeB (gNB), or another type of base station. Some base stations, such as gNB 180 may operate in a traditional sub 6 GHz spectrum, in millimeter wave frequencies, and/or near millimeter wave frequencies in communication with the UE 104. When the gNB 180 operates in millimeter wave or near millimeter wave frequencies, the gNB 180 may be referred to as a millimeter wave base station. The millimeter wave base station 180 may utilize beamforming 182 with the UE 104 to compensate for the path loss and short range. The base station 180 and the UE 104 may each include a plurality of antennas, such as antenna elements, antenna panels, and/or antenna arrays to facilitate the beamforming.

The base station 180 may transmit a beamformed signal to the UE 104 in one or more transmit directions 182′. The UE 104 may receive the beamformed signal from the base station 180 in one or more receive directions 182″. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, an MBMS Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include a Access and Mobility Management Function (AMF) 192, other AMFs 193, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the AMF 192 provides Quality of Service (QoS) flow and session management. All user IP packets are transferred through the UPF 195. The UPF 195 provides UE IP address allocation as well as other functions. The UPF 195 is connected to the IP Services 197. The IP Services 197 may include the Internet, an intranet, an IMS, a Packet Switch (PS) Streaming Service, and/or other IP services.

The base station may include and/or be referred to as a gNB, Node B, eNB, an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may focus on 5G NR, the concepts and various aspects described herein may be applicable to other similar areas, such as LTE, LTE-Advanced (LTE-A), Code Division Multiple Access (CDMA), Global System for Mobile communications (GSM), or other wireless/radio access technologies.

Referring again to FIG. 1, in certain aspects, the UE 104 may include a nominal CSI-RS resource component 198 that is configured to receive a configuration of a reference signal resource for a virtual reference signal that does not occupy a physical resource, and to transmit a report indicating channel information associated with the reference signal resource.

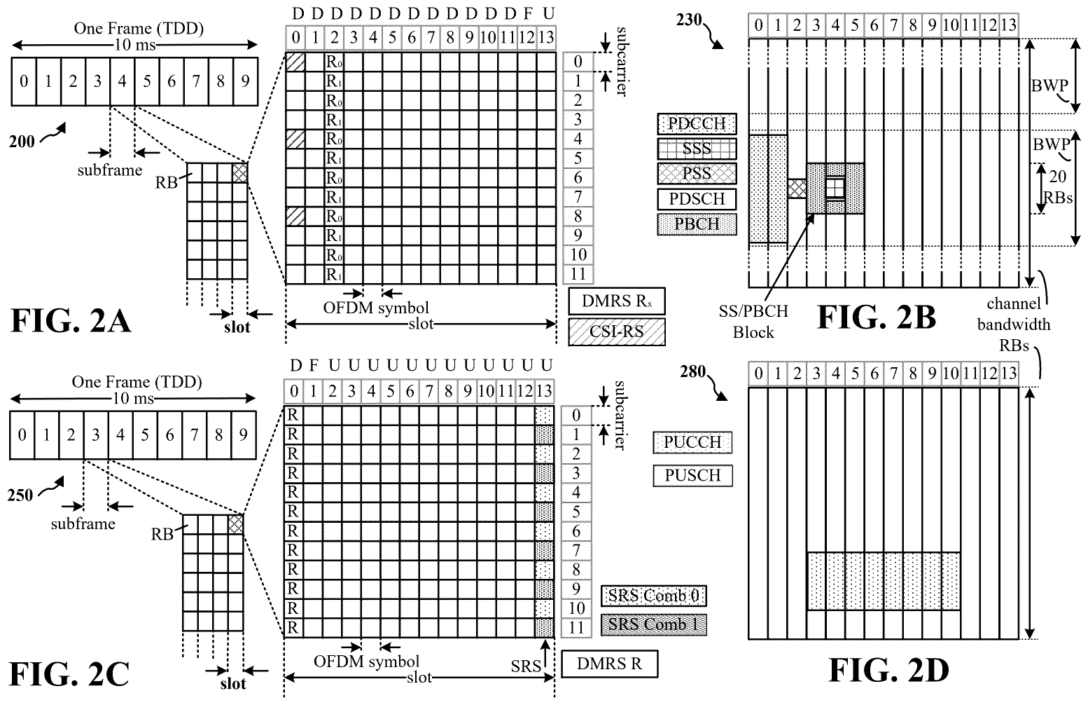

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

Other wireless communication technologies may have a different frame structure and/or different channels. A frame, e.g., of 10 milliseconds (ms), may be divided into 10 equally sized subframes (1 ms). Each subframe may include one or more time slots. Subframes may also include mini-slots, which may include 7, 4, or 2 symbols. Each slot may include 7 or 14 symbols, depending on the slot configuration. For slot configuration 0, each slot may include 14 symbols, and for slot configuration 1, each slot may include 7 symbols. The symbols on DL may be cyclic prefix (CP) orthogonal frequency-division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission). The number of slots within a subframe is based on the slot configuration and the numerology. For slot configuration 0, different numerologies μ0 to 4 allow for 1, 2, 4, 8, and 16 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}*15 kilohertz (kHz), where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as Rₓ for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol. A PDCCH within one BWP may be referred to as a control resource set (CORESET). Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgement (ACK)/non-acknowledgement (NACK) feedback. The PUSCH carries data, and may additionally be used to carry a buffer status report (BSR), a power headroom report (PHR), and/or UCI.

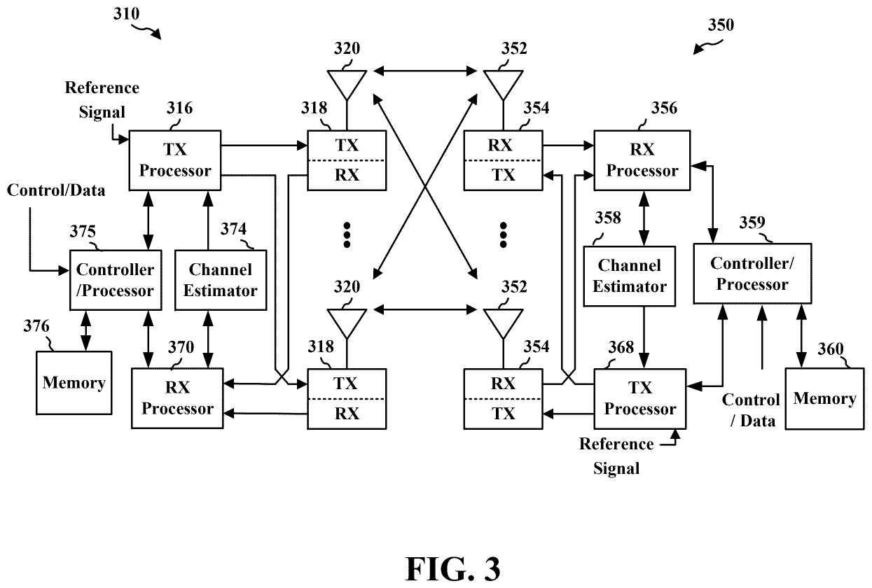

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

At least one of the TX processor 368, the RX processor 356, and the controller/processor 359 may be configured to perform aspects in connection with nominal CSI-RS resource component 198 of FIG. 1.

5G NR (New Radio) supports very high data rates with lower latency in sub-6 GHz and mmW frequency bands compared to LTE (4G) technology. Due to the propagation loss and other losses associated with the very high frequencies of mmW bands, directional communication is generally applied at such frequencies using antenna arrays with large numbers of antenna elements. As these directional links require accurate alignment of transmitted and received beams, beam pair alignment and other beam management operations have been introduced in 5G NR. Such beam management operations may include, for example, beam sweeping (e.g., covering a spatial area with a set of beams according to pre-specified intervals and directions), beam measurement (e.g., evaluation of the quality of a received signal based on metrics such as reference signal receive power (RSRP) or signal to interference and noise ratio (SINR)), beam determination (e.g., selection of one or more suitable or best beams according to the beam measurements), and beam reporting (e.g., reporting beam quality and beam decision information to the base station). Beam management may thus allow UEs that are not in connection with a base station (e.g., in an idle mode or during initial access), and UEs that are in connection with the base station (e.g., in a connected mode, during tracking, or otherwise when the UE is exchanging data with the network), to acquire and maintain a set of transmission and reception beams to be used for uplink and downlink communications, respectively.

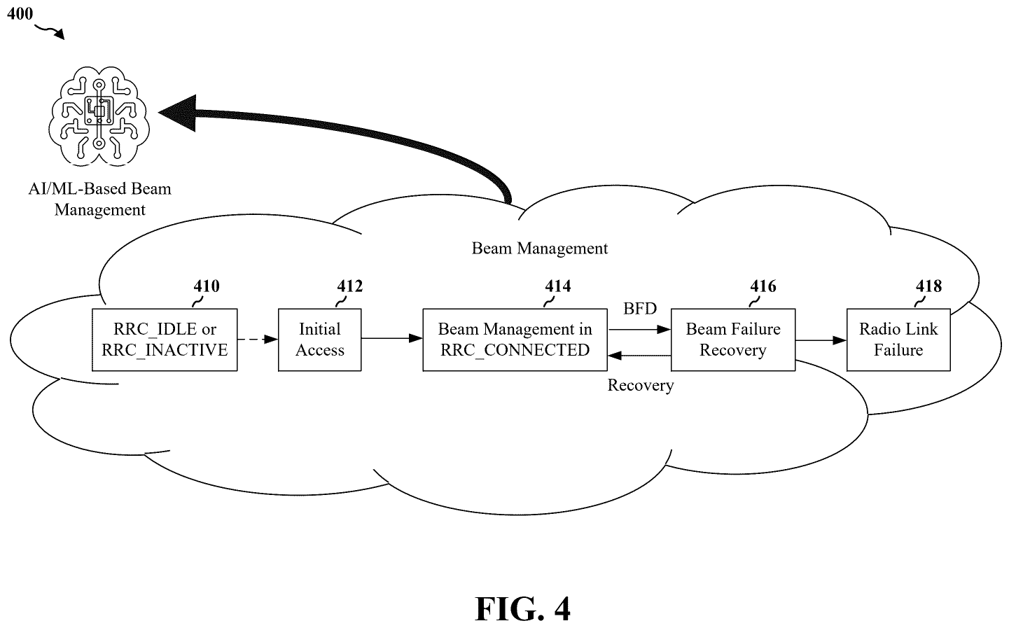

FIG. 4 illustrates an example 400 of beam management operations typically associated with 5G (NR) networks. UEs that are in an RRC_IDLE or RRC_INACTIVE mode 410 may perform beam management using tracking reference signals (TRS) and during initial access 412 using synchronization signal block (SSB) (wide) beam sweeping. SSBs may be associated with random access channel (RACH) occasions (ROs) or RACH preambles with which UEs may perform contention-based random access (CBRA). UEs that are in an RRC_CONNECTED mode 414 may perform various beam management operations, for example, beam selection and refinement using SSBs or CSI-RS (e.g., P1/P2/P3 procedures), beam selection and refinement using SRS (e.g., U1/U2/U3 procedures), layer one (L1)-RSRP reporting, transmission configuration indicator (TCI) state configurations or indications, L1-SINR reporting, and other operations associated with beam management, enhanced beam management (eBM), and further enhanced beam management (FeBM). Connected UEs may also perform beam failure detection (BFD) based on beam measurements, in which case these UEs may perform beam failure recovery (BFR) 416 to remain in RRC_CONNECTED mode. UEs may perform BFD and BFR in primary cells (PCells), primary secondary cells (PSCells), or secondary cells (SCells). Radio link failure 418 is also supported in beam management.

As illustrated in FIG. 4, UEs are also moving towards applying artificial intelligence (AI) or machine learning (ML) for beam management in target use cases for improving performance or reducing complexity of beam management operations. One such target use case in beam management is beam prediction in the time and/or spatial domain, where a base station or UE may utilize an AI/ML model to predict suitable or best beams based on previous beam measurements to reduce overhead and latency and improve accuracy in beam determination or selection. This use case may involve training, deploying, monitoring, and updating the AI/ML model to improve inferences or predictions of best beams for downlink or uplink communications.

AI/ML-based predictive beam management is an attractive alternative to conventional beam management. In conventional beam management, beam qualities or failures are identified via beam measurements. Measuring every beam to determine a best beam or a beam failure may require significant device power or overhead to achieve sufficient performance, limit beam accuracy if restrictions are imposed on the amount of power or overhead that can be used, and impact latency and throughput due to beam resuming efforts. However, in predictive beam management, non-measured beam qualities may be predicted, leading to reduced power and overhead, and future beam blockages or failures may be predicted, leading to improvements in accuracy, latency, or throughput. Moreover, beam prediction itself is a highly non-linear task, and thus AI/ML-based beam prediction may assist in this regard. For example, predicting future transmission beam qualities may depend on a UE's moving speed or trajectory, the reception beams that are or will be used, interference, and other parameters that are difficult to model via conventional statistical signal processing methods.

AI/ML-based beam prediction and training may be performed at a UE or a base station. Generally for predictions, UE performance may outweigh base station performance at the expense of a tradeoff between performance and UE power. For instance, the UE may perform more observations (via measurements) than the base station (via UE feedback) to predict future downlink transmission beam qualities. While this may result in prediction at the UE outperforming prediction at the base station, more UE power is consumed by these inference efforts. For model training, training at the network generally involves effort in data collection while model training at the UE generally involves effort in UE computation. For instance, if model training is conducted at the network, the network may undergo effort in collecting measurement data or other prediction data via the air interface with the UE or via an application-layer approach, while if model training is conducted at the UE, the UE may undertake additional computation or buffering efforts for training and data storage.

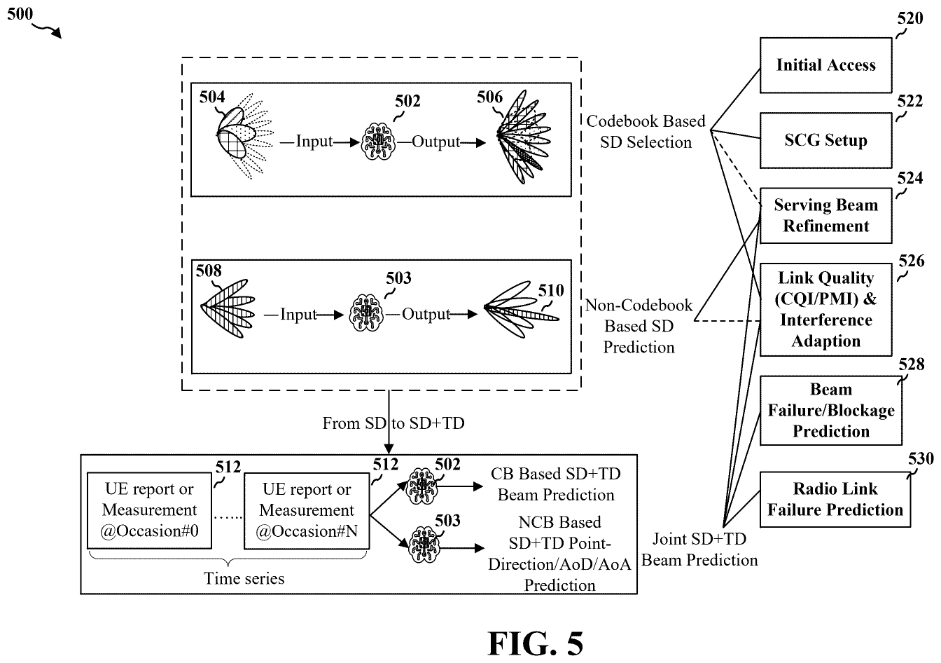

FIG. 5 illustrates an example 500 of spatial domain (SD) and time domain (TD) based beam prediction or selection at the base station or the UE using a ML model 502, 503. Initially, the base station may perform a transmission beam sweep of various transmission beams respectively carrying an SSB or a CSI-RS associated with a different resource identifier. For instance, in one example of spatial domain based beam prediction or selection as illustrated in FIG. 5, a UE may perform L1-RSRP measurements of SSBs carried in wide transmission beams 504 within a given time instance. If beam prediction or selection is performed at the base station, the UE may report these RSRPs to the base station (e.g., in a CSI report) for input to the ML model 502 at the base station. Alternatively, if beam prediction or selection is performed at the UE, the UE may input these measured RSRPs into the ML model 502 at the UE. The ML model 502 in turn may output predicted RSRPs, predicted candidate beams, or predicted beam failures or blockages of narrow transmission beams 506 directed towards the UE. Using these predicted results, the base station or UE may perform codebook-based, spatial domain-based, beam prediction or selection, which may assist in beam management operations related to initial access 520, secondary cell group setup 522, serving beam refinement 524, and link quality (CQI or PMI) and interference adaptation 526. As a result, ML-based beam management may result in less beam measurements being performed at the UE and thereby reduce UE power consumption, since the UE may obtain predicted information regarding one set of beams (i.e., narrow transmission beams 506) from RSRP measurements of a different set of beams (i.e., wide transmission beams 504).

In an another example of spatial domain based beam prediction or selection as illustrated in FIG. 5, a UE may perform L1-RSRP measurements of CSI-RSs carried in narrow transmission beams 508 within a given time instance. If beam prediction or selection is performed at the base station, the UE may report these RSRPs to the base station (e.g., in a CSI report) for input to the ML model 503 at the base station. Alternatively, if beam prediction or selection is performed at the UE, the UE may input these measured RSRPs into the ML model 503 at the UE. The ML model 503 in turn may output a predicted point of direction, angle of descent (AoD), or angle of arrival (AoA) of alternate transmission beam 510 directed towards the UE. Using these predicted results, the base station or UE may perform non-codebook-based, spatial domain-based, beam prediction or selection, which may assist in beam management operations related to serving beam refinement 524 and link quality (CQI or PMI) and interference adaptation 526. As a result, improved beam management accuracy may result without excessive beam sweeping using AI/ML, since the UE may obtain predicted information regarding one set of beams (i.e., alternate transmission beam 510) from RSRP measurements of a different set of beams (i.e., narrow transmission beams 508).

In an additional example of spatial domain and time domain based beam prediction or selection as illustrated in FIG. 5, a UE may perform L1-RSRP measurements of SSBs carried in wide transmission beams 504 or CSI-RS carried in narrow transmission beams 508 within multiple measurement occasions 512. If beam prediction or selection is performed at the base station, the UE may report these RSRPs to the base station (e.g., in a CSI report) for input to the ML model 502, 503 at the base station. Alternatively, if beam prediction or selection is performed at the UE, the UE may input these measured RSRPs into the ML model 502, 503 at the UE. The ML model 502, 503 in turn may output predicted information of narrow transmission beams 506 or alternate transmission beam 510 directed towards the UE, respectively. Using these predicted results, the base station or UE may perform codebook-based or non-codebook based, spatial domain and time domain-based, beam prediction or selection, which may assist in beam management operations related to serving beam refinement 524, link quality (CQI or PMI) and interference adaptation 526, beam failure or blockage prediction 528, and radio link failure prediction 530. As a result, ML-based beam management may result in less beam measurements being performed at the UE and reduce UE power consumption as well as provide improved beam management accuracy without excessive beam sweeping. Moreover, ML-based beam management may increase usable memory capacity in the UE or base station (the device) and extend device battery life.

Thus, in AI/ML-based beam management, a UE or base station may perform a spatial-domain downlink beam prediction, or a temporal downlink beam prediction, of one Set A of beams (e.g., narrow transmission beams 506 or alternate transmission beam 510 in FIG. 5) based on measurement results of another Set B of beams (e.g., L1-RSRPs or L1-SINRs of physical reference signals carried in wide transmission beams 504 or narrow transmission beams 508 in FIG. 5). Set B beams may be a subset of Set A beams or may be otherwise different than Set A beams. For example, Set A beams may include narrow beams while Set B beams may include wide beams, although Set A beams and Set B beams can be different than narrow-wide in other examples. Regardless of how Set A beams or Set B beams are defined, a main difference between these two sets of beams is that while Set B beams carry physical reference signals (e.g., SSBs or CSI-RS), Set A beams may not carry any physical information (e.g., these predicted/selected beams may not actually be transmitted by the base station or received by the UE).

Thus, Set B beams may carry SSBs or CSI-RS (the latter of which is more likely for narrow beams). Currently, there are two types of CSI-RS: non-zero power (NZP) CSI-RS and zero power (ZP) CSI-RS. NZP CSI-RSs are generally used for channel measurement, beam management, and tracking. For instance, a NZP CSI-RS may be configured in a channel measurement resource (CMR) associated with a CSI or L1-RSRP/L1-SINR report. ZP CSI-RSs, in contrast, are generally used for rate matching. An NZP CSI-RS or a ZP CSI-RS may be transmitted periodically, semi-persistently, or aperiodically. An NZP CSI-RS or a ZP CSI-RS may be mapped to a CSI-RS pattern typically associated with 1, 2, 3, 8, 12, 16, 24, or 32 ports, with port multiplexing being based on frequency division multiplexing (FDM) or code division multiplexing (CDM). An NZP CSI-RS resource may also indicate a quasi-colocation (QCL) relationship of the NZP CSI-RS with another reference signal (e.g., an SSB or another CSI-RS). This QCL relationship may be configured via an RRC configuration for periodic NZP CSI-RS (e.g., via a CSI resource configuration for a NZP CSI-RS), indicated via a MAC-CE for semi-persistent NZP CSI-RS (e.g., via a MAC-CE activation command activating the semi-persistent NZP CSI-RS), or indicated via a DCI for aperiodic NZP CSI-RS (e.g., in association with an aperiodic NZP CSI-RS triggering state configuration).

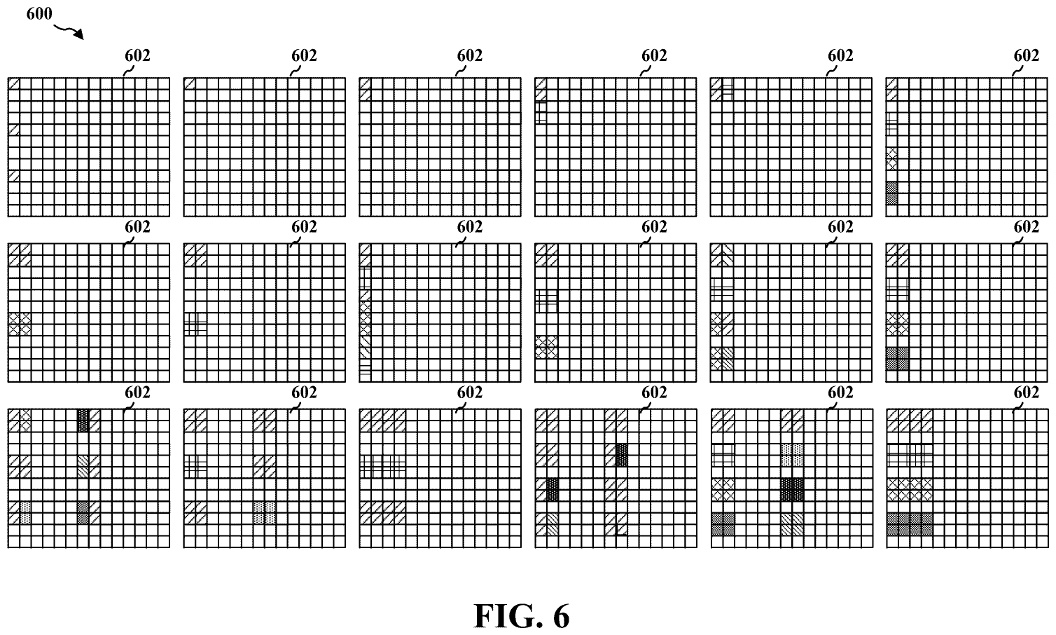

FIG. 6 illustrates an example of CSI-RS patterns 600 that may be configured in respective resource blocks (RBs) 602 for NZP CSI-RS or ZP CSI-RS. CSI-RS patterns 600 may have different numbers of ports (ranging from 1 to 32 ports) and CDM groups, with CSI-RS components occupying various OFDM symbols and subcarriers (i.e., resource elements) in respective slots or RBs 602. CSI-RS components that do not occupy adjacent OFDM symbols may be placed anywhere in a given slot.

In any given slot, a UE may not have more active CSI-RS ports or active CSI-RS resources in active bandwidth parts (BWPs) than those which the UE reported as its capability. Thus, the number of active CSI-RS ports or active CSI-RS resources that the UE may expect to receive in a given slot (e.g., in CSI-RS patterns 600) depends on UE capability. An NZP CSI-RS resource may be considered active in a duration of time depending on whether the CSI-RS is aperiodic, semi-persistent, or periodic. For aperiodic CSI-RS, this duration may span from the end of a PDCCH containing a request for a CSI report until the end of a scheduled PUSCH containing the report associated with this aperiodic CSI-RS. For semi-persistent CSI-RS, this duration may span from the end of when an activation command for the semi-persistent CSI-RS is applied until the end of when a deactivation command for the semi-persistent CSI-RS is applied. For periodic CSI-RS, this duration may span from when the periodic CSI-RS is configured by higher layer signaling until when the periodic CSI-RS configuration is released. In determining the number of active CSI-RS ports or resources that are used by a CSI-RS resource referred to N times by one or more CSI reporting settings, the CSI-RS resource and the CSI-RS ports within the CSI-RS resource are counted N times. Thus, any of the foregoing factors may count towards the maximum number of activated CSI-RS resources or ports indicated in UE capability (and thus the CSI-RS patterns 600 that are available to the UE).

With respect to the capability reporting itself, the base station may require the UE to report the UE's maximum number of configured and activated CSI-RS resources or ports via a parameter for this purpose to the base station (e.g., the parameter csi-RS-IM-ReceptionForFeedback or another name). As the UE typically requires use of hardware or software to process, measure, buffer, or otherwise handle measurement results regarding these CSI-RS resources and ports, this capability signaling may allow the UE to indicate what support the UE has for CSI-RS and CSI interference management (CSI-IM) reception for CSI feedback. Currently, this capability signaling may include at least the following parameters: a maximum number of configured NZP-CSI-RS resources per cell or component carrier (CC) (via parameter maxConfigNumberNZP-CSI-RS-PerCC or another name), a maximum number of ports across all configured NZP-CSI-RS resources per cell or CC (via parameter maxConfigNumberPortsAcrossNZP-CSI-RS-PerCC or another name), a maximum number of configured CSI-IM resources per cell or CC (via parameter maxConfigNumberCSI-IM-PerCC or another name), a maximum number of simultaneous (active) CSI-RS resources per cell or CC (via parameter maxNumberSimultaneousNZP-CSI-RS-PerCC or another name), and a total number of CSI-RS ports in simultaneous (active) CSI-RS resources per cell or CC (via parameter totalNumberPortsSimultaneousNZP-CSI-RS-PerCC or another name). The first three parameters related to configured NZP-CSI-RS resources or ports or CSI-IM resources may refer to RRC-configured resources or ports, while the last two parameters related to simultaneous CSI-RS resources or ports may refer to periodically, semi-persistently, or aperiodically activated resources or ports.

Thus, a UE may receive NZP-CSI-RS in one of multiple CSI-RS patterns 600 based on a maximum number of configured or active CSI-RS resources or ports indicated in a UE capability report. Moreover, to configure the UE to measure and report a signal quality of this NZP-CSI-RS (or of a received SSB), the base station may provide a CSI report configuration indicating the UE which quantity to report (e.g., via a parameter reportQuantity or another name). This report quantity may be the RSRP of a specific SSB index (e.g., reportQuantity=ssb-Index−RSRP), the SINR of a specific SSB index (e.g., reportQuantity=ssb-Index−SINR), the RSRP of a specific CSI-RS index (e.g., reportQuantity=cri−RSRP), or the SINR of a specific CSI-RS index (e.g., reportQuantity=cri−SINR). Thus, the CSI report configuration may configure joint SSB resource indicator (SSBRI)/CSI-RS resource indicator (CRI) and L1-RSRP/L1-SINR beam reporting. Moreover, the CSI report configuration may indicate the UE to report the aforementioned measurements respectively for an RRC configured number of reported reference signals (in parameter nrofReportedRS or another name), which may typically be up to two or four different SSBRI or CRI depending on UE capability for a given CSI report configuration.

Measurement reporting of L1-RSRP may be based on pre-defined measurement report mapping tables. For example, when the UE reports L1-RSRP for a strongest SSBRI or CRI out of a plurality of SSBRIs or CRIs, the UE may report a RSRP value in the inclusive range of [−140, −44] dBm out of 7 bits of RSRP values or code-points respectively separated by a 1 dBm step size (or resolution) in a pre-defined measurement report mapping table. For the remaining SSBRIs or CRIs, the UE may report a differential RSRP value in the inclusive range of [0, −30] dB out of 4 bits of differential RSRP values or code-points respectively separated by a 2 dB step size (or resolution) relative to the strongest SSBRI or CRI's L1-RSRP in another pre-defined measurement report mapping table. As an example, if the UE measures the strongest CRI of a transmission beam sweep to be −45 dBm and the second strongest CRI of the transmission beam sweep to be −48 dBm, the UE may provide a CSI report indicating RSRP_112 for the strongest beam (which may be associated with −45 dBm) and DIFFRSRP_1 for the second strongest beam (which may be associated with ΔRSRP=−3 relative to the strongest beam, or −48 dBm). The available code-points for reporting an L1-RSRP for the strongest beam may be less than the total amount of code-points available for reporting in the associated measurement report mapping table (i.e., there are invalid code-points). For instance, UE may select one of 97 code-points or individual L1-RSRP values measured for the strongest beam from a mapping table including 128 code-points (or bit values out of 7 bits), where the remaining 31 code-points are invalid for L1-RSRP reporting (e.g., the UE may apply those code-points only for layer three (L3)-RSRP reporting).

Measurement reporting of L1-SINR may similarly be based on pre-defined measurement report mapping tables. For example, when the UE reports L1-SINR for a strongest SSBRI or CRI out of a plurality of SSBRIs or CRIs, the UE may report a SINR value in the inclusive range of [−23, 40] dB out of 7 bits of SINR values or code-points respectively separated by a 0.5 dB step size (or resolution) in another pre-defined measurement report mapping table. For the remaining SSBRIs or CRIs, the UE may report a differential SINR value in the inclusive range of [0, −15] dB out of 4 bits of differential SINR values or code-points respectively separated by a 1 dB step size (or resolution) relative to the strongest SSBRI or CRI's L1-SINR in another pre-defined measurement report mapping table. Here, unlike for L1-RSRP, there may be no invalid code-points for reporting an L1-SINR in its associated measurement report mapping table.

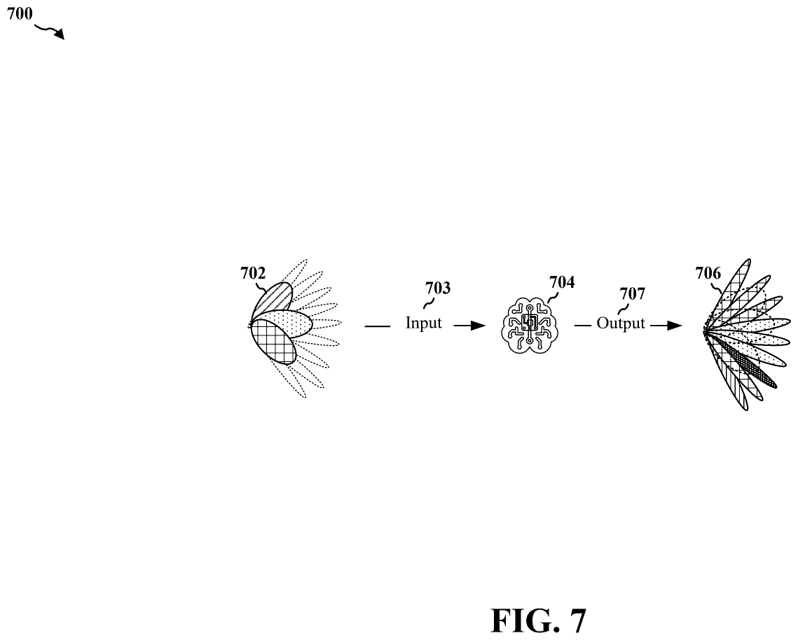

FIG. 7 illustrates an example 700 of UE-based beam prediction in the spatial domain (or in the spatial and temporal domain). Initially, a UE may perform measurements such as L1-RSRP or L1-SINR of reference signals in Set B beams 702. For instance, referring to FIG. 5, the Set B beams 702 may carry SSBs in wide transmission beams 504 or CSI-RS in narrow transmission beams 508. Moreover, referring to FIG. 6, if the Set B beams 702 carry CSI-RS, these CSI-RS may include NZP CSI-RS or ZP CSI-RS received in one of multiple CSI-RS patterns 600 based on a maximum number of configured or active CSI-RS resources or ports indicated in a UE capability report. Following receipt of the reference signals in the Set B beams 702, the UE may input these measurements as input 703 into an AI/ML-based beam prediction model 704 (e.g., ML model 502, 503 of FIG. 5) to derive L1-RSRP(s) or L1-SINR(s) of Set A beams 706 as output 707. For instance, referring to FIG. 5, the Set A beams 706 may include narrow transmission beams 506 or alternate transmission beam 510.

To allow the base station to improve beam management operations based on codebook-based or non-codebook based beam prediction or selection, the UE may intend to report these predicted L1-RSRP(s)/L1-SINR(s) of the Set A beams 706 to the base station, for example, using one or more code-points in the pre-defined measurement report mapping tables. However, as previously described, while Set B beams 702 carry physical reference signals (e.g., SSBs or CSI-RS), Set A beams 706 may not carry any physical information (e.g., these predicted/selected beams may not actually be transmitted by the base station or received by the UE). In other words, Set A beams 706 may be considered to carry virtual reference signals, or more practically, virtual CSI-RS (since Set A beams are generally narrow beams which would not be as conducive for virtual SSBs). However, conventional NZP-CSI-RS configurations and ZP-CSI-RS configurations, which the UE typically applies for L1-RSRP/L1-SINR reporting, assume that respectively indicated CSI-RSs are physical reference signals that are actually transmitted (e.g., by a serving cell or a neighboring non-serving cell). Thus, while current CSI-RS definitions exist for physical reference signals in Set B beams 702, no CSI-RS definitions or resource configurations currently exist for virtual (or “nominal”) reference signals in Set A beams 706.

Therefore, as this lack of definition for nominal CSI-RS resources may cause ambiguity in CSI reporting for such resources, it would be helpful to introduce a configuration mechanism for nominal CSI-RS resources associated with target beams (e.g., Set A beams 706) to better support beam prediction in the spatial domain or the spatial and temporal domain. Likewise, it would be helpful to allow the UE to identify appropriate CSI-RS patterns (e.g., in the time domain, spatial domain, frequency domain, or code domain) and beam shape information for such nominal CSI-RS resources to better support prediction of such resources' CRIs or L1-RSRPs/L1-SINRs. Furthermore, since the UE hardware or software that may be required to process nominal CSI-RS resources and ports may be different than those required for processing physical CSI-RS resources and ports (e.g., due to the heavy involvement of AI/ML computations or neural networks for beam prediction or selection associated with such nominal CSI-RS resources), it would further be helpful to provide additional UE capability signaling for the UE to indicate its supported, maximum number of configured or active nominal CSI-RS resources or ports (e.g., via the parameter csi-RS-IM-ReceptionForFeedback or another name).

To these ends, a UE may be configured, activated, or triggered with a number of nominal CSI-RS resources. The nominal CSI-RS resources may be periodic CSI-RS resources (e.g., RRC configured), semi-persistent CSI-RS resources (e.g., MAC-CE or DCI activated and deactivated), or aperiodic CSI-RS resources (e.g., DCI triggered). These nominal CSI-RS resources may be pre-configured, or configured by a base station, with multiple rules that distinguish these resources from conventional, physical CSI-RS resources. For instance, in one rule, the UE may not expect to receive or measure nominal CSI-RS resources. That is, nominal CSI-RS resources do not occupy physical resources in the time domain, frequency domain, or code domain (e.g., as in Set A beams 706 of FIG. 7). Moreover, in another rule, the UE may expect to report at least a CRI and/or a signal quality metric (e.g., L1-RSRP or L1-SINR) associated with a nominal CSI-RS resource. In one example, the UE may identify L1-RSRPs/L1-SINRs of nominal CSI-RS resources based on SSB measurements of physical SSBs (e.g., in Set B beams 702 of FIG. 7). In another example, the base station or network may configure the UE with an AI/ML model (e.g., AI/ML model 704) in which the UE may input L1-RSRPs/L1-SINRs measured from such SSBs (e.g., in Set B beams), where the output of the AI/ML model includes L1-RSRPs/L1-SINRs associated with such nominal CSI-RS resources. Based on the AI/ML model output, the UE may identify the signal quality metric(s) to be reported for those nominal CSI-RS resources. The configurations of virtual or nominal CSI-RS resources may be referred to as beam index reporting configurations, predictive CSI-RS resource configurations, or other terminologies.

Thus, similar to physical CSI-RS resources, nominal CSI-RS resources may provide a manner for indexing or identifying virtual reference signals so that the UE may determine which resource refers to which transmission beam in Set A beams, and so that the UE may report signal quality metrics for these virtual reference signals accordingly. For example, currently a UE may be configured with 8 physical CSI-RS resources (or other number of resources) in different transmission beams, which associated CSI-RSs the UE may measure, and the UE may report a single CRI for one of the measured beams (e.g., one of the CRI #s 1-8 corresponding to a best beam) and the L1-RSRP/L1-SINR associated with that physical CSI-RS resource. Similarly here, the UE may be configured with nominal CSI-RS resources associated with different transmission beams and CRIs associated with virtual reference signals (which are not transmitted), and the UE may similarly report CRI for one of the predicted beams and/or the L1-RSRP/L1-SINR associated with that nominal CSI-RS resource. As an example, rather than the UE being configured to receive eight physical CSI-RS #1-8 as previously noted, here the UE may be configured with four physical CSI-RS resources with CRI #s 1, 3, 5, 7 (corresponding to the set B beams) and four nominal CSI-RS resources with CRI #s 2, 4, 6, 8 (corresponding to the set A beams), and the UE may predict and report one of nominal CRI #s 2, 4, 6, 8 (e.g., the best beam or prediction result) based on a measurement result of one of the physical CRI #s 1, 3, 5, 7. The nominal CSI resources may thus provide references for the UE to report one or more predicted/selected set A beams based on one or more received/measured set B beams. As a result, in contrast to conventional beam prediction approaches, here the nominal CSI-RS resource configurations allow the UE to measure signals in less transmission beams, to switch between fewer reception beams in determining a best beam pair, and to receive less physical reference signals in wireless communication, thereby allowing the UE to save power consumption, experience reduced latency, and communicate with reduced overhead.

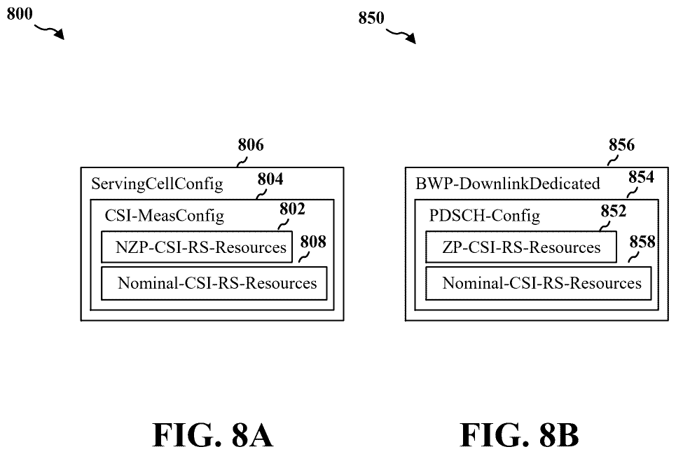

FIGS. 8A and 8B illustrate examples 800, 850 of nominal CSI-RS resource configurations. As illustrated in example 800 of FIG. 8A, NZP CSI-RS resources 802 are typically indicated per serving cell in a CSI measurement configuration 804, which in turn, may be configured in a serving cell configuration 806. Moreover, as illustrated in example 850 of FIG. 8B, ZP CSI-RS resources 852 are typically indicated in a PDSCH configuration 854, which in turn, may be configured per BWP in a downlink dedicated BWP configuration 856. However, as nominal CSI-RS resources are different than NZP CSI-RS resources and ZP CSI-RS resources, the base station may configure these resources differently to allow the UE to determine whether a CSI-RS resource relates to a virtual reference signal or a physical reference signal. Thus, in the examples of FIGS. 8A and 8B, nominal CSI-RS resources 808, 858 may be configured as a separate type of CSI-RS resource than NZP CSI-RS resources 802 and ZP CSI-RS resources 852. For instance, in the example 800 of FIG. 8A, nominal CSI-RS resources 808 may be configured in parallel with NZP CSI-RS resources 802 within CSI measurement configuration 804 (in which case these virtual resources may be configured per serving cell), while in the example 850 of FIG. 8B, nominal CSI-RS resources 858 may be configured in parallel with ZP CSI-RS resources 852 within PDSCH configuration 854 (in which case these virtual resources may be configured per BWP).

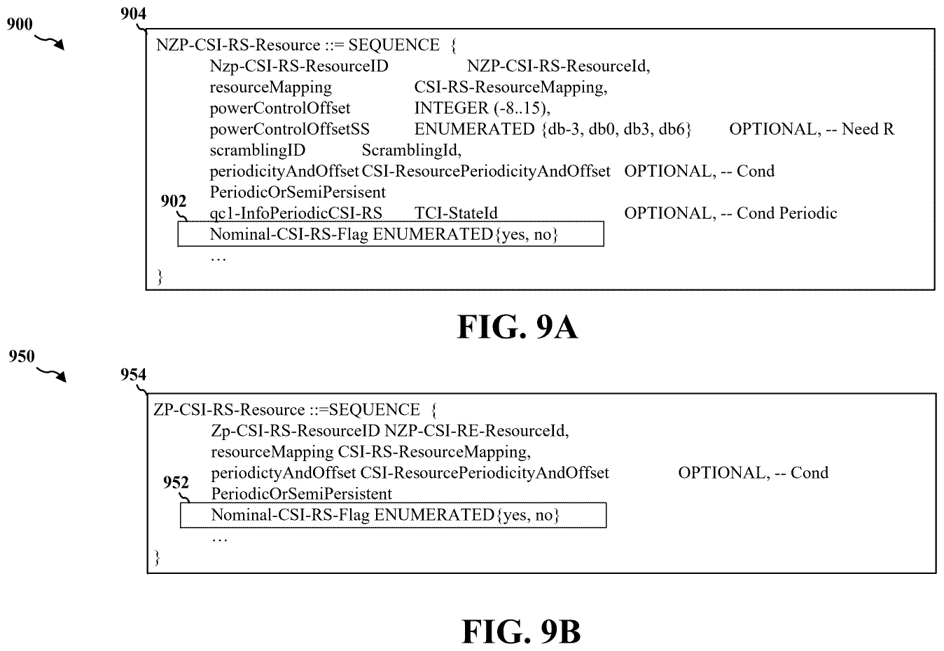

FIGS. 9A and 9B illustrate examples 900, 950 of other nominal CSI-RS resource configurations. Unlike the examples 800, 850 of FIGS. 8A and 8B in which nominal CSI-RS resources are defined in separate configurations than NZP CSI-RS resources or ZP CSI-RS resources, here in the examples 900, 950 of FIGS. 9A and 9B, nominal CSI-RS resources may be defined within the same resource configuration as the NZP CSI-RS resources or ZP CSI-RS resources. For instance, in the examples 900, 950 of FIGS. 9A and 9B, an additional field 902, 952 or flag may be defined within a NZP CSI-RS resource configuration 904 or ZP CSI-RS resource configuration 954, respectively, which indicates whether the associated CSI-RS resource is a nominal CSI-RS resource or a conventional NZP or ZP CSI-RS resource. For example, if the flag is set to ‘yes’, the resource is configured as a nominal CSI-RS resource associated with a virtual reference signal, while if the flag is set to ‘no’, the resource is configured as a NZP or ZP CSI-RS resource associated with a physical reference signal. The NZP CSI-RS resource configuration 904 and ZP CSI-RS resource configuration 954 may include the additional field 902, 952 among other fields typically present in such resource configurations, such as a CSI-RS resource identifier, a CSI-RS resource mapping, a periodicity and offset, and the like (e.g., the other fields illustrated).

In either examples 800, 850 of FIGS. 8A and 8B or examples 900, 950 of FIGS. 9A and 9B, the nominal CSI-RS resource configuration may be based on a UE reported capability to receive such configurations or fields. For instance, different UEs may have different capabilities in terms of beam prediction. That is, some UEs may be capable of carrying out beam predictions of set A beams that are not actually transmitted, while other UEs may not be able to carry out such predictions on virtual reference signals. Accordingly, the UE may report to the base station its capability indicating whether the UE can receive such configurations or fields as described with respect to FIGS. 8A, 8B, 9A, and/or 9B. Thus, regardless of how nominal CSI-RS resources may be configured, the BS may determine to send such nominal CSI-RS resource configurations to the UE in response to receiving a capability indication from the UE indicating that the UE is capable of handling such nominal CSI-RS resources. Conversely, if the UE indicates that it is incapable of handling such nominal CSI-RS resources, the base station may not include such nominal CSI-RS configurations in its RRC configuration(s).

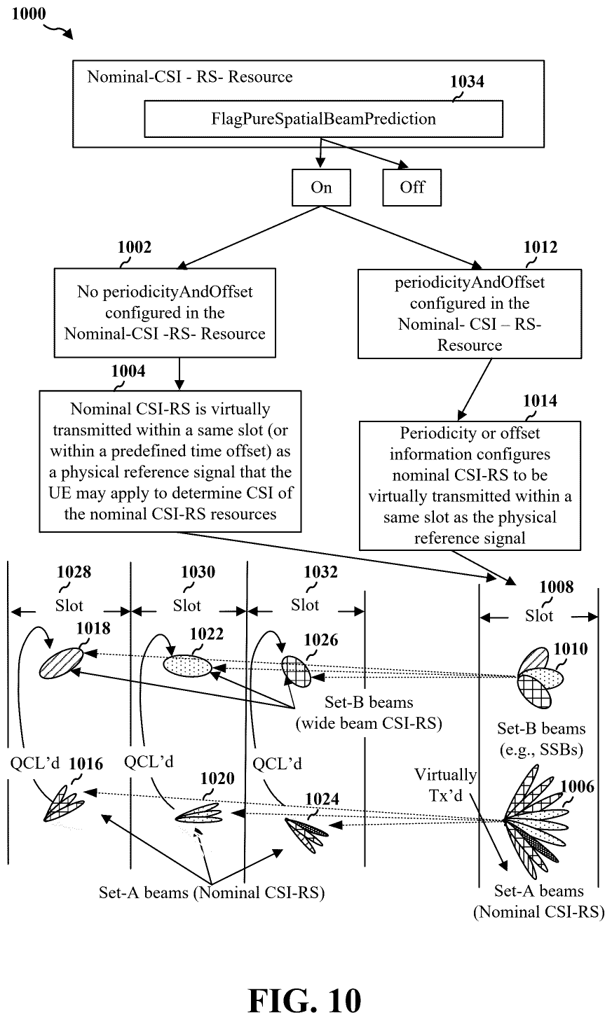

FIG. 10 illustrates an example 1000 of a time domain pattern configuration for a nominal CSI-RS resource. Although nominal CSI-RS are not physically transmitted, the time domain pattern configuration of a nominal CSI-RS resource may allow the UE to determine in which time occasion such nominal CSI-RS would be transmitted if such CSI-RS was physically transmitted. In other words, this time domain pattern configuration may indicate to the UE the virtual transmission timing pattern of a nominal CSI-RS, and the UE may predict the signal quality associated with this virtually transmitted reference signal based on this timing.

In a first example of the time domain pattern configuration for a nominal CSI-RS resource, the UE may not expect an RRC configuration of the nominal CSI-RS resource to comprise periodicity or offset information, even though periodicity or offset information is generally configured in periodic or semi-persistent NZP CSI-RS resources. In such case, the UE may assume that a nominal CSI-RS associated with such nominal CSI-RS resource is virtually transmitted within a same slot (or within a predefined time offset) as a physical reference signal (e.g., a SSB or CSI-RS) that the UE may apply to determine the L1-RSRPs/L1-SINRs/CRIs of the nominal CSI-RS resources. For example, referring to FIG. 10, if the UE determines at block 1002 that a nominal CSI-RS resource configuration (e.g., configured according to the examples of FIGS. 8A, 8B, 9A, or 9B) lacks periodicity and offset information, the UE may determine at block 1004 that the virtual reference signal associated with the configured nominal CSI-RS resource in a Set A beam 1006 is virtually transmitted within a same slot 1008 as a physical reference signal associated with a conventional CSI-RS resource in a Set B beam 1010. The UE may determine the physical reference signal or Set B beam 1010, for example, based on a specific reference (e.g., a QCL reference or other specific reference) to that CSI-RS resource in the nominal CSI-RS resource configuration, and the UE may assume that the nominal CSI-RS is virtually transmitted in the same slot 1008 (or an offset with respect to that slot) configured for this referenced physical CSI-RS resource. The UE may then determine via spatial beam prediction the L1-RSRP/L1-SINR of the Set A beam 1006 in the slot or offset associated with the Set B beam 1010.

In a second example of the time domain pattern configuration for a nominal CSI-RS resource, the UE may expect an RRC configuration of the nominal CSI-RS resource to comprise periodicity or offset information identical to that of a physical reference signal (e.g., a SSB or CSI-RS) that the UE may apply to determine the L1-RSRP/L1-SINR/CRI of the nominal CSI-RS resource. In such case, the UE may assume that the periodicity or offset information configures a nominal CSI-RS associated with such nominal CSI-RS resource to be virtually transmitted within a same slot as the physical reference signal. For example, referring to FIG. 10, if the UE determines at block 1012 that a nominal CSI-RS resource configuration (e.g., configured according to the examples of FIGS. 8A, 8B, 9A, or 9B) includes periodicity and offset information, the UE may determine at block 1014 that the periodicity and offset information indicates a virtual reference signal associated with the configured nominal CSI-RS resource in the Set A beam 1006 to be virtually transmitted within the same slot 1008 as a physical reference signal associated with a conventional CSI-RS resource in the Set B beam 1010. The UE may then determine via spatial beam prediction the L1-RSRP/L1-SINR of the Set A beam 1006 in the slot associated with the Set B beam 1010.

Thus, regardless of whether the periodicity and offset information is included or not in the nominal CSI-RS resource configuration, the UE may determine the nominal CSI-RS to be virtually transmitted in the same slot as the physical CSI-RS. In the first example, this determination may be based on pre-defined or pre-configured associations between virtual reference signal timing and physical reference signal timing in the first example (following block 1002 and 1004). In the second example, this determination may be based on an expectation of expressly indicated periodicity and offset information for the virtual reference signal timing matching that of the physical reference signal timing (following block 1012 and 1014). Additionally, in either the first or second example, this determination may be further based on a rule that the nominal CSI-RS is virtually transmitted within a same slot as a source QCL reference signal. For example, referring to FIG. 10, the base station may configure nominal CSI-RS resources for respective ones of the Set A beams 1006 with associated source QCL references, such that nominal CSI-RS #s 1-3 in a first portion 1016 of the Set A beams 1006 are QCL'ed with SSB #1 in a first beam 1018 of the Set B beams 1010, nominal CSI-RS #s 4-6 in a second portion 1020 of the Set A beams 1006 are QCL'ed with SSB #2 in a second beam 1022 of the Set B beams 1010, and nominal CSI-RS #s 7-9 in a third portion 1024 of the Set A beams 1006 are QCL'ed with SSB #3 in a third beam 1026 of the Set B beams 1010. In such case, the UE may determine that the nominal CSI-RS #s 1-3 are virtually transmitted within a same slot 1028 or occasion as QCL'ed SSB #1, the nominal CSI-RS #s 4-6 are transmitted within a same slot 1030 or occasion as QCL'ed SSB #2, and the nominal CSI-RS #s 7-9 are transmitted within a same slot 1032 or occasion as QCL'ed SSB #3.

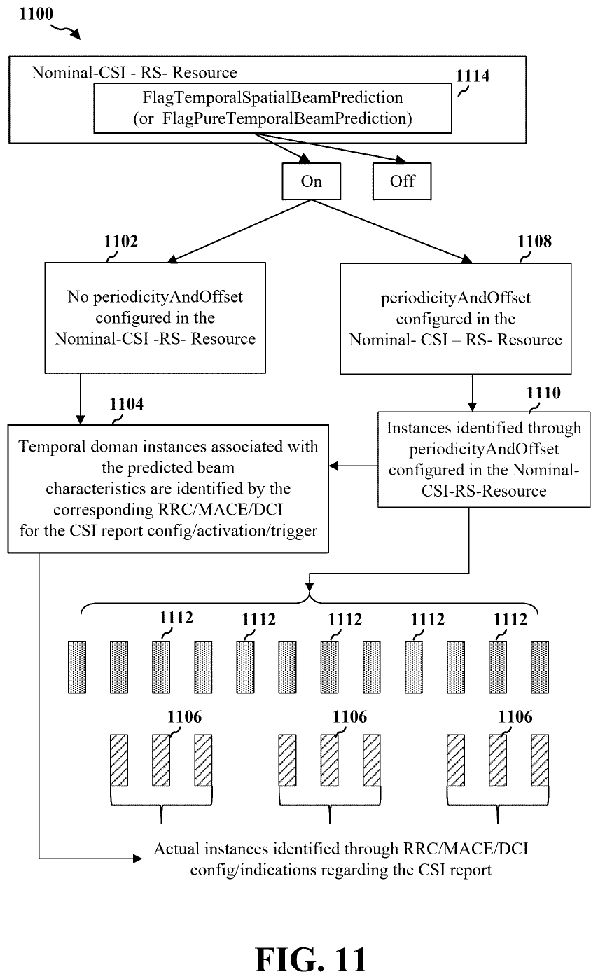

In any of the foregoing examples described with respect to FIG. 10 regarding time domain pattern configurations for nominal CSI-RS resources, a nominal CSI-RS (the predicted resource) is virtually transmitted at the same time as its associated physical CSI-RS (the measurement resource). Therefore, these time domain pattern configurations relate to pure, spatial domain beam prediction (in contrast to pure temporal beam prediction or joint spatial and temporal beam prediction as described below with respect to FIG. 11). Accordingly, in one example, the aforementioned pre-configurations or configurations of nominal CSI-RS time domain patterns may be conditional on the associated nominal CSI-RS resources being configured for pure spatial domain beam prediction. For instance, in the example of FIG. 10, the nominal CSI-RS resource configuration may include a spatial beam prediction flag 1034, and in response to determining that this flag 1034 is enabled or ‘on’, the UE may perform the foregoing operations described in connection with the aforementioned examples of FIG. 10 (e.g., blocks 1002, 1004, 1012, 1014, etc.).

FIG. 11 illustrates an example 1100 of another time domain pattern configuration for a nominal CSI-RS resource. Similar to the example 1000 of FIG. 10, this time domain pattern configuration may indicate to the UE the virtual transmission timing pattern of a nominal CSI-RS, and the UE may predict the signal quality associated with this virtually transmitted reference signal based on this timing. However, in contrast to the example 1000 of FIG. 10 in which the time domain pattern is identical to that of a physical CSI-RS resource for purposes of spatial beam prediction, in this example 1100 of FIG. 11, the time domain pattern may be different than that of a physical CSI-RS resource for purposes of temporal beam prediction. Additionally, the time domain patterns may be configured such that nominal CSI-RS and physical CSI-RS occur in at least one same time instance or occasion for purposes of joint spatial and temporal beam prediction.

In a first example of a time domain pattern configuration for a nominal CSI-RS resource, the UE may not expect an RRC configuration of the nominal CSI-RS resource to comprise periodicity or offset information, similar to the first example of FIG. 10. In such case, the UE may determine the temporal domain instances associated with spatial or joint spatial/temporal beam prediction (the time occasions of nominal CSI-RS) from a message configuring, activating, or triggering a CSI report including CSI associated with the beam prediction. This message may be, for example, a RRC-configured CSI report setting for a periodic or semi-persistently scheduled CSI report, a MAC-CE for a semi-persistently scheduled CSI report, or a DCI for an aperiodic CSI report. For instance, referring to FIG. 11, if the UE determines at block 1102 that a nominal CSI-RS resource configuration (e.g., configured according to the examples of FIGS. 8A, 8B, 9A, or 9B) lacks periodicity and offset information, the UE may determine at block 1104 that the virtual reference signal associated with the configured nominal CSI-RS resource in a Set A beam is virtually transmitted within a plurality of time instances 1106. The plurality of time instances 1106 may be configured (via RRC), activated (via MAC-CE), or triggered (via DCI) in a CSI report configuration for reporting L1-RSRP/L1-SINR/CRI measurements of physical reference signals associated with conventional CSI-RS resources in Set B beams. The UE may then determine via temporal or joint spatial/temporal beam prediction the L1-RSRP/L1-SINR/CRI of the Set A beams associated with time instances 1106 based on the Set B beams.

In a second example of a time domain pattern configuration for a nominal CSI-RS resource, the UE may expect an RRC configuration of the nominal CSI-RS resource to comprise periodicity or offset information, similar to the second example of FIG. 10. In such case, as in the first example of FIG. 11, the UE may determine the temporal domain instances associated with the spatial or joint spatial/temporal beam prediction (the time occasions of nominal CSI-RS) from a message configuring, activating, or triggering a CSI report including CSI associated with beam prediction. The message may similarly be either an RRC-configured CSI report setting for a periodic or semi-persistently scheduled CSI report, a MAC-CE for a semi-persistently scheduled CSI report, or a DCI for an aperiodic CSI report. However, unlike the first example of FIG. 11, in this second example the UE may further determine additional temporal domain instances for the nominal CSI-RS indicated in the configured periodicity or offset information. Therefore, the UE may determine to align these additional temporal domain instances with the aforementioned temporal domain instances associated with the CSI reporting for purposes of the beam prediction.

For instance, referring to FIG. 11, if the UE determines at block 1108 that a nominal CSI-RS resource configuration (e.g., configured according to the examples of FIGS. 8A, 8B, 9A, or 9B) includes periodicity and offset information, the UE may determine at block 1110 that the virtual reference signal associated with the configured nominal CSI-RS resource in a Set A beam is virtually transmitted within a plurality of configured time instances 1112 indicated in the periodicity and offset information. Moreover, the UE may further determine at block 1104 the plurality of time instances 1106 configured (via RRC), activated (via MAC-CE), or triggered (via DCI) in the CSI report configuration for reporting L1-RSRP/L1-SINR/CRI measurements of physical reference signals associated with conventional CSI-RS resources in Set B beams. The UE may then determine via temporal or joint spatial/temporal beam prediction the L1-RSRP/L1-SINR/CRI of the Set A beams associated with the configured time instances 1112 that overlap or align with time instances 1106 based on the Set B beams.

Thus, regardless of whether the periodicity and offset information is included or not in the nominal CSI-RS resource configuration, the UE may determine the temporal domain instances in which nominal CSI-RS is virtually transmitted for purposes of temporal beam prediction or joint spatial/temporal beam prediction of Set A beams. In the first example, this determination may be based on pre-defined or pre-configured associations between virtual reference signal timing and physical reference signal timing indicated in the associated CSI report configuration (following block 1102 and 1104). In the second example, this determination may be based on an expectation of expressly indicated periodicity and offset information for the virtual reference signal timing matching that of the physical reference signal timing indicated in the associated CSI report configuration (following block 1108, 1110, and 1104). In either example, the UE may apply the time instances associated with physical reference signals in measured Set B beams to the virtual reference signals in predicted Set A beams, where if the time instances do not overlap, pure temporal beam prediction may apply, while if at least one of the time instances overlap, joint temporal and spatial beam prediction may apply.

In any of the foregoing examples described with respect to FIG. 11 regarding time domain pattern configurations for nominal CSI-RS resources, nominal CSI-RSs (the predicted resources) may be virtually transmitted at different time instances, and in some cases also at a same time instance, as associated physical CSI-RSs (the measurement resources). Therefore, these time domain pattern configurations relate to either pure, temporal domain beam prediction or joint, temporal and spatial domain beam prediction. Accordingly, in one example, the aforementioned pre-configurations or configurations of nominal CSI-RS time domain patterns may be conditional on the associated nominal CSI-RS resources being configured for pure temporal domain beam prediction or joint temporal and spatial domain beam prediction. For instance, in the example of FIG. 11, the nominal CSI-RS resource configuration may include a temporal beam prediction flag 1114, and in response to determining that this flag 1114 is enabled or ‘on’, the UE may perform the foregoing operations described in connection with the aforementioned examples of FIG. 11 (e.g., blocks 1102, 1104, 1108, 1110, etc.).

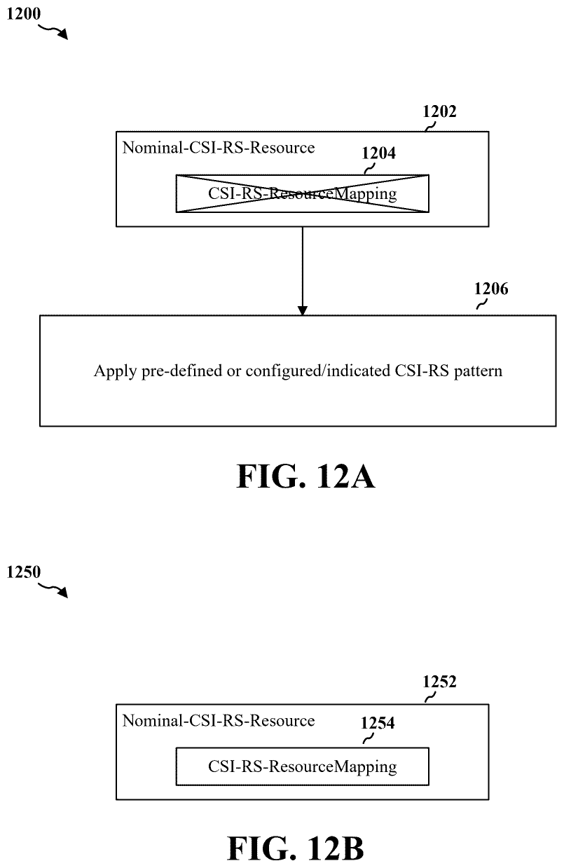

FIGS. 12A-12B illustrate examples 1200, 1250 of CSI-RS pattern configurations (in the spatial domain, frequency domain, or code domain) for a nominal CSI-RS resource. Although nominal CSI-RS are not physically transmitted, the CSI-RS pattern configuration of a nominal CSI-RS resource may allow the UE to determine the resource elements that would be occupied (and thus the transmission powers associated with such resource elements) if such CSI-RS was physically transmitted. In other words, this CSI-RS pattern configuration may indicate to the UE the virtual resource mapping of a nominal CSI-RS, and the UE may predict the signal quality associated with this virtually transmitted reference signal based on this resource mapping. For example, the UE may calculate virtual RSRPs at the REs indicated in the virtual resource mapping associated with nominal CSI-RS resource (e.g., by summarizing the RSRPs predicted for the respective REs), and the UE may report the summarized virtual L1-RSRP (and/or the associated CRI) of the nominal CSI-RS resource for the base station to predict a best associated Set A beam accordingly.

In a first example of a CSI-RS pattern configuration for a nominal CSI-RS resource, the UE may not expect a CSI-RS resource mapping to be configured in an RRC configuration for the nominal CSI-RS resource. For instance, as illustrated in FIG. 12A, a nominal CSI-RS resource configuration 1202 may lack a CSI-RS resource mapping configuration 1204 typically associated with conventional CSI-RS resource configurations (e.g., a configuration CSI-RS-ResourceMapping or another name). In such case, the UE may determine at block 1206 to apply a pre-defined CSI-RS pattern or a separately configured or indicated CSI-RS pattern by the base station for such nominal CSI-RS resource when predicting a CRI and/or L1-RSRP/L1-SINR associated with this resource.

In one example, this pre-defined or separately configured/indicated CSI-RS pattern for a nominal CSI-RS resource (e.g., a Set A beam) may be identical to a spatial, frequency, or code domain CSI-RS pattern configured for a physical CSI-RS resource which the UE applies as a measurement source (e.g., a Set B beam) for the nominal CSI-RS resource. For example, if a Set B beam is associated with one of the CSI-RS patterns 600 of FIG. 6, the set A beam may be associated with the same CSI-RS pattern. In another example, this pre-defined or separately configured/indicated CSI-RS pattern for a nominal CSI-RS resource may be a specific, pre-configured one of the CSI-RS patterns 600 of FIG. 6, notwithstanding whether this virtual CSI-RS pattern is the same as, or different than, a physical CSI-RS pattern configured for an associated Set B beam. For example, a nominal CSI-RS resource may be predefined with the CSI-RS pattern 600 illustrated in the top left most portion of FIG. 6 (i.e., a single port CSI-RS resource occupying 3 REs per PRB, using the first OFDM symbol within the slot, and spanning the active BWP in the frequency domain, as indicated in the illustrated example of FIG. 12A). In other examples, the base station may configure or indicate the CSI-RS pattern for a nominal CSI-RS resource associated with a Set A beam in a message associated with CSI reporting of the nominal CSI-RS resource. This message may be, for example, an RRC-configured CSI report setting associated with CRI and/or L1-RSRP/L1-SINR reporting of the nominal CSI-RS resource, a MAC-CE activating a semi-persistent report of the CRI and/or L1-RSRP/L1-SINR of the nominal CSI-RS resource, or a DCI triggering an aperiodic report of the CRI and/or L1-RSRP/L1-SINR of the nominal CSI-RS resource. In any of the foregoing examples, the UE may calculate the L1-RSRP/L1-SINR and/or determine the CRI associated with this nominal CSI-RS resource based on the REs indicated in the pre-configured or separately configured/indicated spatial, frequency, or code domain pattern.

In a second example of a CSI-RS pattern configuration for a nominal CSI-RS resource, the UE may expect a CSI-RS resource mapping to be configured in an RRC configuration for the nominal CSI-RS resource. For instance, as illustrated in FIG. 12B, a nominal CSI-RS resource configuration 1252 may include a CSI-RS resource mapping configuration 1254 similar to that associated with conventional CSI-RS resource configurations (e.g., a configuration CSI-RS-ResourceMapping or another name). In such case, the UE may determine to apply the CSI-RS pattern associated with the CSI-RS resource mapping configuration 1254 for such nominal CSI-RS resource when predicting a CRI and/or L1-RSRP/L1-SINR associated with this resource. For example, the nominal CSI-RS resource associated with a Set A beam may be configured or indicated with one of the CSI-RS patterns 600 of FIG. 6, in which case the UE may calculate the L1-RSRP/L1-SINR and/or determine the CRI associated with this nominal CSI-RS resource based on the REs indicated in the spatial, frequency, or code domain pattern.

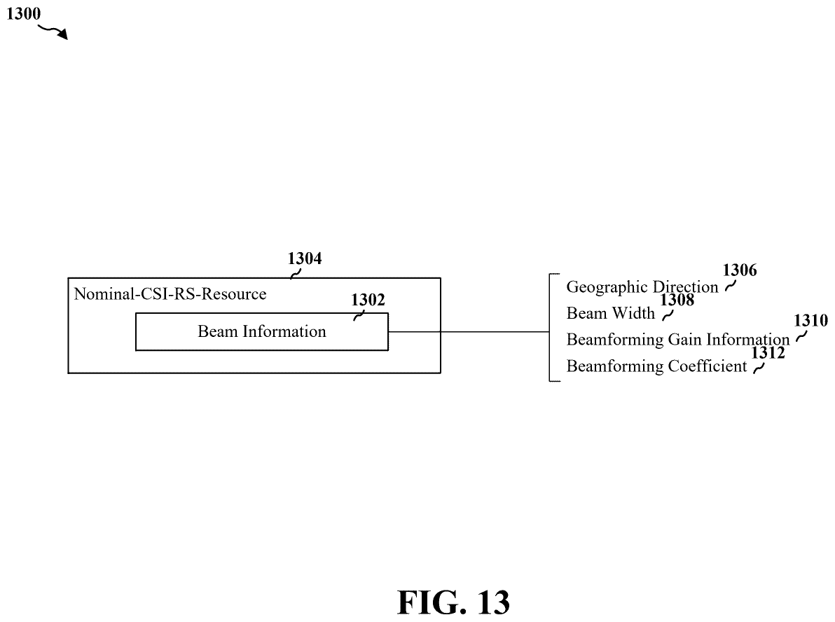

FIG. 13 illustrates an example 1300 of beam information 1302 for a nominal CSI-RS resource 1304. Typically with physical CSI-RS resources, beam information may be configured which indicates beam shapes or other parameters of transmission beams carrying physical CSI-RS, and reported CSI associated with such physical CSI-RS may depend on this beam information. For example, CSI may differ for wide transmission beams and for narrow transmission beams. Similarly, although nominal CSI-RSs are not physically transmitted, a UE may apply beam shape information associated with such nominal CSI-RSs to predict CSI (e.g., CRIs and/or L1-RSRP/L1-SINR) that may similarly depend on this virtual beam information. The beam information 1302 may include, for example, a geographical direction 1306 associated with a boresight of a transmission beam associated with the nominal CSI-RS resource, a beam width 1308 of a transmission beam associated with the nominal CSI-RS resource (e.g., an X-dB beam width in an angular domain with respect to a peak beamforming gain, where X is an integer), beamforming gain information 1310 associated with an angle of a transmission beam associated with the nominal CSI-RS resource, or a beamforming coefficient 1312 (digital or analog) associated with the nominal CSI-RS resource.

Thus, a UE may expect beam information 1302 (e.g., transmission beam shape information) to be configured, activated, or triggered for nominal CSI-RS resources. In one example, the beam information 1302 may be included in an RRC configuration of nominal CSI-RS resource 1304. For instance, one of the configurations according to the examples of FIGS. 8A, 8B, 9A, or 9B may include the beam information 1302 for the nominal CSI-RS resource 1304. In another example, the beam information 1302 may be included in a MAC-CE activation command for the nominal CSI-RS resource 1304. For instance, a MAC-CE activating a nominal semi-persistent CSI-RS resource may include the beam information 1302 for the nominal CSI-RS resource 1304. In a further example, the beam information 1302 may be included in a MAC-CE activation command which activates the UE to provide a report including predicted CSI (e.g., CRI and/or L1-RSRP/L1-SINR) for the nominal CSI-RS resource 1304. For instance, a MAC-CE activating the CSI report for the nominal CSI-RS resource may include the beam information 1302 for the nominal CSI-RS resource 1304. In an additional example, the beam information 1302 may be included in a trigger configuration for an aperiodic CSI report including predicted CSI (e.g., CRI and/or L1-RSRP/L1-SINR) for the nominal CSI-RS resource 1304. For instance, a DCI triggering the CSI report for the nominal CSI-RS resource may include the beam information 1302 for the nominal CSI-RS resource 1304.

Based on such beam information associated with a nominal CSI-RS resource, the UE may predict CRI and/or L1-RSRP/L1-SINR for the nominal CSI-RS resource. For example, the UE may input beam information 1302 associated with the nominal CSI-RS resource 1304 including one or more of geographic direction 1306, beam width 1308, beamforming gain information 1310, or beamforming coefficient 1312 into an AI/ML model (e.g., ML model 502, 503, ML-based beam prediction model 704) to obtain a CRI and/or L1-RSRP/L1-SINR associated with the nominal CSI-RS resource 1304 as an output from the AI/ML model. Additionally, the UE may further predict CRI and/or L1-RSRP/L1-SINR for the nominal CSI-RS resource (e.g., associated with a Set A beam) based on similar beam shape information associated with a physical CSI-RS resource configuration (e.g., associated with a Set B beam) which the UE may be receive from a base station. For instance, in addition to inputting the beam information 1302 associated with nominal CSI-RS resource 1304 in its AI/ML model such as previously described, the UE may input similar beam information associated with a physically transmitted SSB or CSI-RS in its AI/ML model to output the predicted CRI and/or L1-RSRP/L1-SINR associated with the nominal CSI-RS resource 1304.

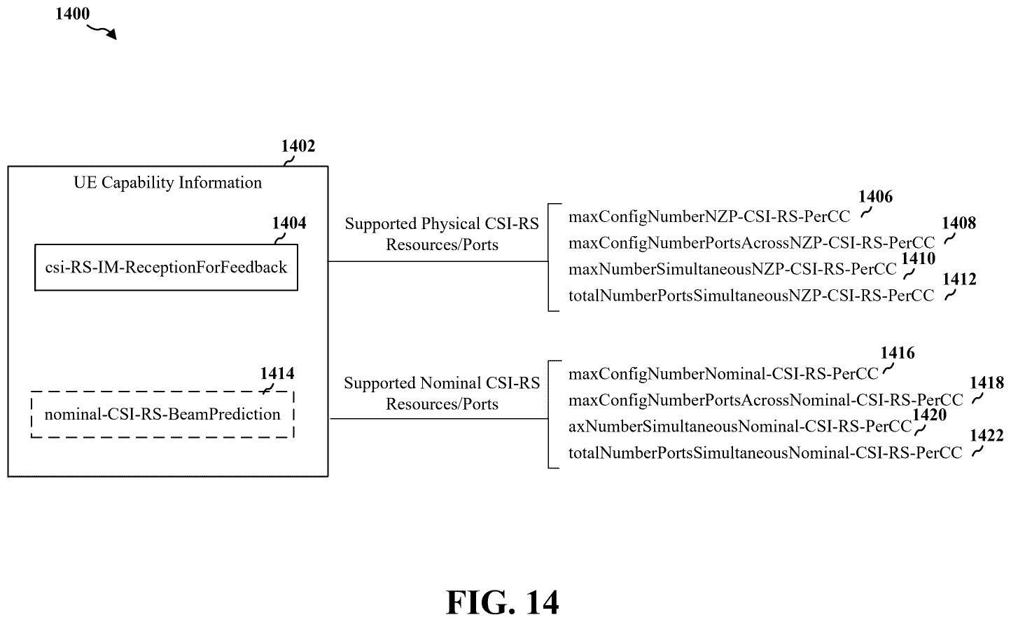

FIG. 14 illustrates an example 1400 of UE capability information 1402 indicating a maximum number of configurable or active nominal CSI-RS resources or ports. As previously described with respect to UE capability, a UE may report to the base station its maximum number of supported physical CSI-RS resources and ports (e.g., NZP CSI-RS resources) that are configured and activated for CSI feedback. For instance, in NZP CSI-RS capability category 1404 (e.g., via the parameter csi-RS-IM-ReceptionForFeedback or another name), the UE may report a first NZP CSI-RS capability 1406 including a maximum number of configured NZP-CSI-RS resources per CC, a second NZP CSI-RS capability 1408 including a maximum number of ports across all configured NZP-CSI-RS resources per CC, a third NZP CSI-RS capability 1410 including a maximum number of simultaneous (active) CSI-RS resources per CC, and a fourth NZP CSI-RS capability 1412 including a total number of CSI-RS ports in simultaneous (active) CSI-RS resources per CC.

Similarly, in NZP CSI-RS capability category 1404 or in a separate, nominal CSI-RS capability category 1414, the UE may report similar capabilities for nominal CSI-RS resources and ports. For instance, the UE may report a first nominal CSI-RS capability 1416 including a maximum number of configured nominal CSI-RS resources per cell or CC (e.g., via parameter maxConfigNumberNominal-CSI-RS-PerCC or another name), a second nominal CSI-RS capability 1418 including a maximum number of ports across all configured nominal CSI-RS resources per cell or CC (e.g., via parameter maxConfigNumberPortsAcrossNominal-CSI-RS-PerCC or another name), a third nominal CSI-RS capability 1420 including a maximum number of simultaneous (active) nominal CSI-RS resources per CC (e.g., via parameter maxNumberSimultaneousNominal-CSI-RS-PerCC or another name), and a fourth nominal CSI-RS capability 1422 including a total number of CSI-RS ports in simultaneous (active) nominal CSI-RS resources per CC (e.g., via parameter totalNumberPortsSimultaneousNominal-CSI-RS-PerCC or another name). First nominal CSI-RS capability 1416 and second nominal CSI-RS capability 1418 may refer to RRC-configured resources or ports, while third nominal CSI-RS capability 1420 and fourth nominal CSI-RS capability 1422 may refer to periodically, semi-persistently, or aperiodically activated resources or ports for a duration of time.

Thus, a UE may report in UE capability information 1402 its capability for processing different types of CSI-RS resources (e.g., NZP CSI-RS and nominal CSI-RS). For example, just as UEs typically require hardware of software to process, measure, buffer, or otherwise handle measurement results regarding physical CSI-RS resources and ports, UEs that are capable of processing nominal CSI-RS resources and ports may similarly require hardware or software to process nominal CSI-RS resources and ports. As illustrated in example 1400 of FIG. 14, separate capabilities may be reported for nominal CSI-RS resources than for physical CSI-RS resources, rather than a single capability for both nominal and physical CSI-RS resources, so that backwards compatibility may be maintained for UEs that are not capable of processing nominal CSI-RS resources. Moreover, certain UEs may share hardware or software to handle both types of resources with similar complexity, while other UEs may independently handle both types of resources. Therefore, different examples may exist in terms of whether a UE's NZP CSI-RS capability category 1404 (i.e., the UE's maximum number of configured or active physical CSI-RS resources and ports) considers or is alternatively independent of a UE's nominal CSI-RS capability category 1414 (i.e., the UE's maximum number of configured or active nominal CSI-RS resources and ports).

In one example, a configured or active nominal CSI-RS resource may be considered as a configured or active CSI-RS resource in total (including physical and nominal resources), such that the NZP CSI-RS capability category 1404 reported by the UE (e.g., its maximum number of configured or active CSI-RS resources and ports) takes into account the nominal CSI-RS capability category 1414 (e.g., its maximum configured or active nominal CSI-RS resources or ports). For instance, this example may apply in the scenario where a UE that is originally capable of simultaneously activating 8 NZP CSI-RS resources if the UE were not processing nominal CSI-RS resources, would not be capable of simultaneously activating the same 8 NZP CSI-RS resources if the UE were to also simultaneously activate 4 nominal CSI-RS resources. In such case, if the UE were to report that it can simultaneously activate 8 NZP CSI-RS resources in NZP CSI-RS capability category 1404 and 4 nominal CSI-RS resources in nominal CSI-RS capability category 1414, the UE may only activate 8 CSI-RS resources in total (e.g., at least four physical and at most four nominal in various combinations, such as 4 and 4; 5 and 3; 6 and 2; 7 and 1; or 8 and 0).

In another example, a configured or active nominal CSI-RS resource may not be considered as a configured or active CSI-RS resource in total (including physical and nominal resources), such that the NZP CSI-RS capability category 1404 reported by the UE (e.g., its maximum number of configured or active CSI-RS resources and ports) does not take into account the nominal CSI-RS capability category 1414 (e.g., its maximum configured or active nominal CSI-RS resources or ports). For instance, this example may apply in the scenario where a UE that is originally capable of simultaneously activating 8 NZP CSI-RS resources if the UE were not processing nominal CSI-RS resources, would still be capable of simultaneously activating the same 8 NZP CSI-RS resources if the UE were to also simultaneously activate 4 nominal CSI-RS resources. In such case, if the UE were to report that it can simultaneously activate 8 NZP CSI-RS resources in NZP CSI-RS capability category 1404 and 4 nominal CSI-RS resources in nominal CSI-RS capability category 1414, the UE may activate 12 CSI-RS resources in total (e.g., at most eight physical and at most four nominal in various combinations). Thus, the UE may activate physical CSI-RS resources independently of nominal CSI-RS resources in this example.

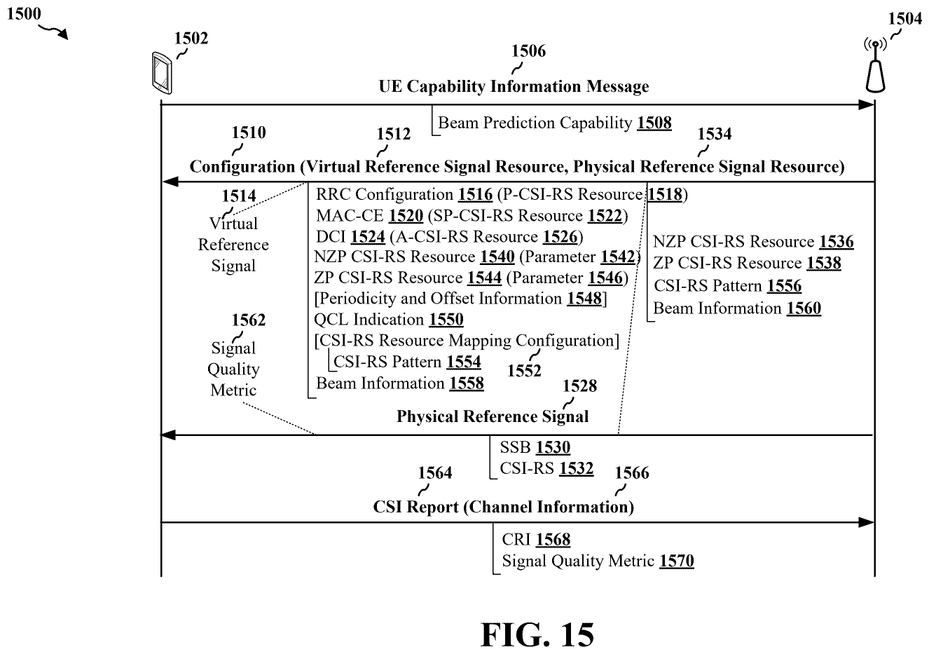

FIG. 15 is a diagram illustrating an example 1500 of a call flow between a UE 1502 and a base station 1504. Initially, the UE 1502 may transmit a UE capability information message 1506 to the base station indicating a beam prediction capability 1508 of the UE 1502. For instance, the beam prediction capability 1508 may indicate whether or not the UE 1502 is capable of carrying out beam predictions of set A beams associated with virtual reference signals that are not physically transmitted. The UE capability information message 1506 may also include NZP CSI-RS capability categories and nominal CSI-RS capability categories, such as described with respect to FIG. 14.

In response to the UE capability information message 1506 indicating beam prediction capability 1508, the base station 1504 may transmit configuration 1510 indicating a virtual reference signal resource 1512 to the UE 1502. The base station may transmit configuration 1510, for example, if the beam prediction capability 1508 indicates that the UE is capable of handling a virtual reference signal 1514 associated with such virtual reference signal resource 1512. The virtual reference signal resource 1512 may be a nominal CSI-RS resource indicated, for example, in a RRC configuration 1516 as a periodic CSI-RS resource 1518, in a MAC-CE 1520 as a semi-persistent CSI-RS resource 1522, or in a DCI 1524 as an aperiodic CSI-RS resource 1526. In contrast to a physical reference signal 1528 such as an SSB 1530 or a CSI-RS 1532 (e.g., a NZP CSI-RS or a ZP CSI-RS) that the UE 1502 may physically receive from base station 1504 in an actual transmission beam (i.e., a Set B beam), the virtual reference signal 1514 does not occupy a physical resource (e.g., a slot, resource element, or PRB) but represents a CSI-RS resource associated with a predicted transmission beam (i.e., a Set A beam).

Configuration 1510 may include the virtual reference signal resource 1512 as well as a physical reference signal resource 1534 associated with the physical reference signal 1528. Physical reference signal resource 1534 may be, for example, a NZP CSI-RS resource 1536 or a ZP CSI-RS resource 1538. Virtual reference signal resource 1512 may be indicated in a separate configuration within configuration 1510 from physical reference signal resource 1534. For instance, configuration 1510 may be a CSI measurement configuration separately including NZP CSI-RS resource 1536 and virtual reference signal resource 1512 (e.g., as described with respect to FIG. 8A), or a PDSCH configuration separately including ZP CSI-RS resource 1538 and virtual reference signal resource 1512 (e.g., as described with respect to FIG. 8B). Alternatively, virtual reference signal resource 1512 may be indicated in a same configuration within configuration 1510 as physical reference signal resource 1534. For instance, virtual reference signal resource 1512 may be a NZP CSI-RS resource 1540 including a parameter 1542 indicating its association with virtual reference signal 1514 (e.g., as described with respect to FIG. 9A), or virtual reference signal resource 1512 may be a ZP CSI-RS resource 1544 including a parameter 1546 similarly indicating its association with virtual reference signal 1514 (e.g., as described with respect to FIG. 9B).

Configuration 1510 may or may not include periodicity and offset information 1548 associated with the virtual reference signal resource 1512. If periodicity and offset information 1548 is lacking, virtual reference signal resource 1512 may be pre-configured to be associated with a same slot or plurality of time instances as physical reference signal resource 1534 (e.g., as described with respect to blocks 1002 and 1004 of FIG. 10 or blocks 1102 and 1104 of FIG. 11). If periodicity and offset information 1548 is included, virtual reference signal resource 1512 may be explicitly configured to be associated with a same slot or plurality of time instances as physical reference signal resource 1534 (e.g., as described with respect to blocks 1012 and 1014 of FIG. 10 or blocks 1104, 1108, and 1110 of FIG. 11). Moreover, configuration 1510 may include a QCL indication 1550 indicating a QCL relationship between virtual reference signal 1514 and physical reference signal 1528. In such case, QCL indication 1550 may indicate to UE 1502 that virtual reference signal resource 1512 and physical reference signal resource 1534 are associated with a same slot (e.g., same slot 1028, 1030, 1032 described with respect to FIG. 10).

Configuration 1510 may or may not include a CSI-RS resource mapping configuration 1552 indicating a CSI-RS pattern 1554. If CSI-RS resource mapping configuration 1552 is lacking, the CSI-RS pattern 1554 associated with virtual reference signal resource 1512 may be a pre-defined, configured, or indicated CSI-RS pattern matching one of those patterns illustrated in FIG. 6 (e.g., as described with respect to FIG. 12A). For example, CSI-RS pattern 1554 may be pre-defined to match a CSI-RS pattern 1556 associated with physical reference signal resource 1534. If CSI-RS resource mapping configuration 1552 is included, the CSI-RS pattern 1554 associated with virtual reference signal resource 1512 may be as indicated in the CSI-RS resource mapping configuration 1552 (e.g., as described with respect to FIG. 12B).

Configuration 1510 may also include beam information 1558 indicating beam shapes or other parameters associated with virtual reference signal resource 1512. For instance, beam information 1558 may include a geographic direction of a transmission beam for the virtual reference signal 1514, a beam width of the transmission beam, beamforming gain information associated with an angle of the transmission beam, or a beamforming coefficient associated with the virtual reference signal, such as described with respect to FIG. 13. Similarly, physical reference signal resource 1534 may also be associated with beam information 1560 for physical reference signal 1528.

After receiving physical reference signal 1528 from base station 1504, UE 1502 may obtain a signal quality metric 1562 of the physical reference signal 1528. For example, UE 1502 may measure an L1-RSRP or an L1-SINR of the physical reference signal 1528. Subsequently, UE 1502 may transmit a CSI report 1564 including channel information 1566 associated with virtual reference signal resource 1512. For example, channel information 1566 may include a CRI 1568 or a signal quality metric 1570 (e.g., an L1-RSRP or an L1-SINR) associated with virtual reference signal resource 1512, which UE 1502 may predict based on the signal quality metric 1562 of physical reference signal 1528 (associated with a Set B beam). Alternatively or additionally, UE 1502 may derive channel information 1566 based on an output of an AI/ML model which predicts a Set A beam based on inputs such as the aforementioned parameters of virtual reference signal resource 1512 and/or physical reference signal resource 1534 (e.g., such as described with respect to FIGS. 5 and 7).

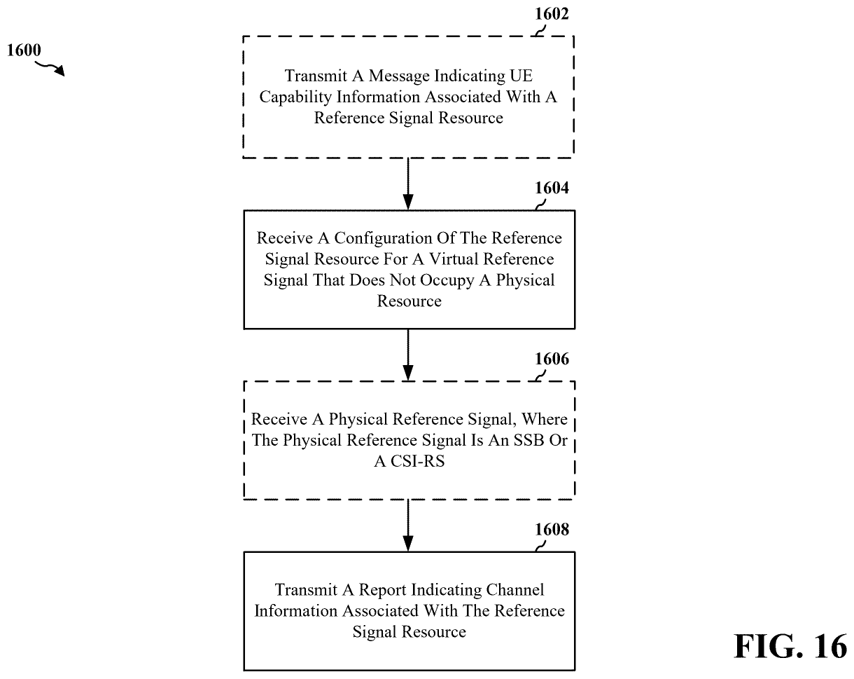

FIG. 16 is a flowchart 1600 of a method of wireless communication. The method may be performed by a UE (e.g., the UE 104, 350, 1502; the apparatus 1702). Optional aspects are illustrated in dashed lines. The method allows a UE to be configured with nominal CSI resources which provide virtual references for the UE to report channel information for one or more predicted or selected Set A beams (e.g., based on one or more received or measured set B beams).

At 1602, the UE may transmit a message indicating UE capability information associated with a reference signal resource. For example, 1602 may be performed by message component 1740. For instance, referring to FIG. 15, the UE 1502 may transmit UE capability information message 1506 associated with virtual reference signal resource 1512 (a nominal CSI-RS resource). For example, the UE capability information message 1506 may include nominal CSI-RS capability category 1414, such as described with respect to FIG. 14. The UE capability information may include at least one of: a first maximum quantity of configured reference signal resources for a component carrier (e.g., first nominal CSI-RS capability 1416), a second maximum quantity of antenna ports across the configured reference signal resources (e.g., second nominal CSI-RS capability 1418), a third maximum quantity of simultaneous reference signal resources for the component carrier (e.g., third nominal CSI-RS capability 1420), or a total quantity of the antenna ports in the simultaneous reference signal resources (e.g., fourth nominal CSI-RS capability 1422).

At 1604, the UE receives a configuration of the reference signal resource for a virtual reference signal that does not occupy a physical resource. For example, 1604 may be performed by configuration component 1742. For instance, referring to FIG. 15, UE 1502 may receive configuration 1510 indicating virtual reference signal resource 1512 (e.g., a nominal CSI-RS resource) associated with virtual reference signal 1514. The virtual reference signal 1514 may not occupy a physical resource (e.g., a slot, resource element, or PRB) but may represent a CSI-RS resource associated with a predicted transmission beam (i.e., a Set A beam). In one example, the reference signal resource may be a periodic CSI-RS resource indicated in an RRC configuration, a semi-persistent CSI-RS resource activated in a MAC-CE, or an aperiodic CSI-RS resource triggered in downlink control information. For instance, virtual reference signal resource 1512 may be a nominal CSI-RS resource indicated, for example, in RRC configuration 1516 as periodic CSI-RS resource 1518, in MAC-CE 1520 as semi-persistent CSI-RS resource 1522, or in DCI 1524 as aperiodic CSI-RS resource 1526.

In one example, the configuration may include a plurality of different types of CSI-RS resources, a first one of the different types being the reference signal resource, and a second one of the different types being a NZP CSI-RS resource or a ZP CSI-RS resource. For instance, referring to FIG. 15, virtual reference signal resource 1512 may be indicated in a separate configuration within configuration 1510 from physical reference signal resource 1534 (e.g., NZP CSI-RS resource 1536 or ZP CSI-RS resource 1538). In one example, the configuration may be a CSI measurement configuration, and the second one of the different types may be the NZP CSI-RS resource. For instance, referring to FIG. 15, configuration 1510 may be a CSI measurement configuration (e.g., CSI measurement configuration 804) separately including NZP CSI-RS resource 1536 and virtual reference signal resource 1512 (e.g., as described with respect to FIG. 8A). In another example, the configuration may be a PDSCH configuration, and the second one of the different types may be the ZP CSI-RS resource. For instance, referring to FIG. 15, configuration 1510 may be a PDSCH configuration (e.g., PDSCH configuration 854) separately including ZP CSI-RS resource 1538 and virtual reference signal resource 1512 (e.g., as described with respect to FIG. 8B).

In one example, the reference signal resource may be a NZP CSI-RS resource or a ZP CSI-RS resource, and the reference signal resource may further include a parameter indicating that the virtual reference signal does not occupy the physical resource. For instance, referring to FIG. 15, virtual reference signal resource 1512 may be indicated in a same configuration within configuration 1510 as physical reference signal resource 1534 (e.g., NZP CSI-RS resource 1536 or ZP CSI-RS resource 1538). For instance, virtual reference signal resource 1512 may be NZP CSI-RS resource 1540 including parameter 1542 (e.g., additional field 902) indicating its association with virtual reference signal 1514 (e.g., as described with respect to FIG. 9A), or virtual reference signal resource 1512 may be ZP CSI-RS resource 1544 including parameter 1546 (e.g., additional field 952) similarly indicating its association with virtual reference signal 1514 (e.g., as described with respect to FIG. 9B).

In one example, the configuration may be received at 1604 based on a capability of the apparatus to predict a transmission beam based on the virtual reference signal. For instance, referring to FIG. 15, UE capability information message 1506 may indicate beam prediction capability 1508, which may indicate whether or not the UE 1502 is capable of carrying out beam predictions of set A beams associated with virtual reference signals that are not physically transmitted. In response to the UE capability information message 1506 indicating beam prediction capability 1508, the UE 1502 may receive configuration 1510 indicating a virtual reference signal resource 1512 from base station 1504. The base station may transmit configuration 1510, for example, if the beam prediction capability 1508 indicates that the UE 1502 is capable of handling virtual reference signal 1514 associated with such virtual reference signal resource 1512.

At 1606, the UE may receive a physical reference signal, where the physical reference signal is a SSB or a CSI-RS. For example, 1606 may be performed by reference signal component 1744. For instance, referring to FIG. 15, UE 1502 may receive physical reference signal 1528 such as SSB 1530 or CSI-RS 1532 (e.g., a NZP CSI-RS or a ZP CSI-RS). Physical reference signal 1528 may be associated with physical reference signal resource 1534 and may be physically received from base station 1504 in an actual transmission beam (i.e., a Set B beam).

In one example, the virtual reference signal may be mapped to a slot associated with the physical reference signal based on the reference signal resource lacking periodicity and offset information for the virtual reference signal. For instance, referring to FIG. 15, configuration 1510 may not include periodicity and offset information 1548 associated with virtual reference signal resource 1512, in which case virtual reference signal resource 1512 may be pre-configured to be associated with a same slot (e.g., same slot 1008) as physical reference signal resource 1534 (e.g., as described with respect to blocks 1002 and 1004 of FIG. 10).

In one example, the reference signal resource may include periodicity and offset information for the virtual reference signal, and the virtual reference signal may be mapped to a slot associated with the physical reference signal based on the periodicity and offset information. For instance, referring to FIG. 15, configuration 1510 may include periodicity and offset information 1548 associated with virtual reference signal resource 1512, in which case virtual reference signal resource 1512 may be explicitly configured to be associated with a same slot (e.g., same slot 1008) as physical reference signal resource 1534 (e.g., as described with respect to blocks 1012 and 1014 of FIG. 10).

In one example, the reference signal resource may include an indication that the physical reference signal is quasi co-located with the virtual reference signal, and the virtual reference signal may be mapped to a slot associated with the physical reference signal based on the indication. For instance, referring to FIG. 15, configuration 1510 may include QCL indication 1550 indicating a QCL relationship between virtual reference signal 1514 and physical reference signal 1528. In such case, QCL indication 1550 may indicate to UE 1502 that virtual reference signal resource 1512 and physical reference signal resource 1534 are associated with a same slot (e.g., same slot 1028, 1030, 1032 such as described with respect to FIG. 10).

In one example, the reference signal resource may include an indication that the reference signal resource is associated with beam prediction in a spatial domain, and the virtual reference signal may be mapped to a slot associated with the physical reference signal based on the indication. For instance, referring to FIGS. 10 and 15, virtual reference signal resource 1512 (e.g., the nominal CSI-RS resource) may include spatial beam prediction flag 1034, and in response to determining that this flag 1034 is enabled or ‘on’, the UE 1502 may perform the foregoing operations described in connection with the aforementioned examples of FIG. 10 (e.g., blocks 1002, 1004, 1012, 1014, etc. in response to which virtual reference signal resource 1512 and physical reference signal resource 1534 may be associated with same slot 1008, 1028, 1030, 1032).

At 1608, the UE transmits a report indicating channel information associated with the reference signal resource. For example, 1608 may be performed by report component 1746. The channel information may include at least one of a CRI associated with the reference signal resource, or a signal quality metric associated with the reference signal resource. For instance, referring to FIG. 15, UE 1502 may transmit CSI report 1564 including channel information 1566 associated with virtual reference signal resource 1512. For example, channel information 1566 may include the CRI 1568 or the signal quality metric 1570 (e.g., L1-RSRP or L1-SINR) associated with virtual reference signal resource 1512. In one example, the channel information may be based on the physical reference signal received at 1606. For instance, referring to FIG. 15, UE 1502 may predict channel information 1566 (associated with a Set A beam) based on the signal quality metric 1562 of physical reference signal 1528 (associated with a Set B beam). For example, the UE 1502 may identify L1-RSRPs/L1-SINRs of nominal CSI-RS resources based on SSB measurements of physical SSBs (e.g., in Set B beams 702 of FIG. 7), although the Set B beams are not limited to carrying SSBs. As an example, the UE may be configured with four physical CSI-RS resources with CRI #s 1, 3, 5, 7 (corresponding to the set B beams) and four nominal CSI-RS resources with CRI #s 2, 4, 6, 8 (corresponding to the set A beams), and the UE may predict and report one of nominal CRI #s 2, 4, 6, 8 (e.g., the best beam or prediction result) based on a measurement result of one of the physical CRI #s 1, 3, 5, 7.

In another example, a signal quality metric of the physical reference signal may be an input of an ML model of the apparatus, and the channel information associated with the reference signal resource may be based on an output of the ML model. For instance, referring to FIG. 15, UE 1502 may derive channel information 1566 based on an output of an AI/ML model (e.g., AI/ML-based beam prediction model 704; ML model 502, 503) which predicts a Set A beam based on inputs such as configured parameters and/or measurements of virtual reference signal resource 1512 and/or physical reference signal resource 1534 (e.g., signal quality metric 1562). As an example, the base station 1504 may configure the UE 1502 with an AI/ML model (e.g., AI/ML model 704) in which the UE 1502 may input L1-RSRPs/L1-SINRs measured from SSBs (e.g., in Set B beams), where the output of the AI/ML model includes L1-RSRPs/L1-SINRs associated with nominal CSI-RS resources. Based on the AI/ML model output, the UE may identify the signal quality metric(s) to be reported for those nominal CSI-RS resources.

In one example, the channel information may be transmitted at 1608 in a CSI report associated with a plurality of time instances for transmission beam prediction, and the virtual reference signal may be mapped to each of the time instances based on the reference signal resource lacking periodicity and offset information for the virtual reference signal. In this example, the time instances may be indicated in an RRC configuration, activated in a MAC-CE, or triggered in DCI. For instance, referring to FIG. 15, configuration 1510 may not include periodicity and offset information 1548 associated with virtual reference signal resource 1512, in which case virtual reference signal resource 1512 may be pre-configured to be associated with a same plurality of time instances (e.g., time instances 1106) as physical reference signal resource 1534 (e.g., as described with respect to blocks 1102 and 1104 of FIG. 11). The UE 1502 may determine via temporal or joint spatial/temporal beam prediction the L1-RSRP/L1-SINR/CRI of the Set A beams associated with time instances 1106 based on the Set B beams, and the UE 1502 may transmit CSI report 1564 reporting channel information 1566 accordingly (e.g., the predicted L1-RSRP/L1-SINR/CRI measurements associated with these time instances and Set A beams). The plurality of time instances 1106 may be configured (via RRC), activated (via MAC-CE), or triggered (via DCI) in a CSI report configuration for the CSI report 1564.

In one example, the channel information may be transmitted at 1608 in a CSI report associated with a plurality of time instances for transmission beam prediction, the reference signal resource may include periodicity and offset information for the virtual reference signal, and the virtual reference signal may be mapped to each of the time instances based on the periodicity and offset information. In this example, the time instances may similarly be indicated in an RRC configuration, activated in a MAC-CE, or triggered in DCI. For instance, referring to FIG. 15, configuration 1510 may include periodicity and offset information 1548 associated with virtual reference signal resource 1512, in which case virtual reference signal resource 1512 may be explicitly configured to be associated with a same plurality of time instances (e.g., time instances 1106 that overlap or align with configured time instances 1112) as physical reference signal resource 1534 (e.g., as described with respect to blocks 1104, 1108, and 1110 of FIG. 11). The UE may determine via temporal or joint spatial/temporal beam prediction the L1-RSRP/L1-SINR/CRI of the Set A beams associated with the configured time instances 1112 that overlap or align with time instances 1106 based on the Set B beams, and the UE 1502 may transmit CSI report 1564 reporting channel information 1566 accordingly (e.g., the predicted L1-RSRP/L1-SINR/CRI measurements associated with these time instances and Set A beams). The plurality of time instances 1106 may be configured (via RRC), activated (via MAC-CE), or triggered (via DCI) in a CSI report configuration for the CSI report 1564.

In one example, the channel information may be transmitted in a CSI report associated with a plurality of time instances for transmission beam prediction, the reference signal resource may include an indication that the reference signal resource is associated with the transmission beam prediction in a temporal domain, and the virtual reference signal may be mapped to each of the time instances based on the indication. For instance, referring to FIGS. 11 and 15, virtual reference signal resource 1512 (e.g., the nominal CSI-RS resource) may include temporal beam prediction flag 1114, and in response to determining that this flag 1114 is enabled or ‘on’, the UE 1502 may perform the foregoing operations described in connection with the aforementioned examples of FIG. 11 (e.g., blocks 1102, 1104, 1108, 1110, etc. in response to which virtual reference signal resource 1512 and physical reference signal resource 1534 may be associated with the same plurality of time instances 1106). The UE 1502 may determine via temporal or joint spatial/temporal beam prediction the L1-RSRP/L1-SINR/CRI of the Set A beams associated with time instances 1106 or with the configured time instances 1112 that overlap or align with time instances 1106 based on the Set B beams, and the UE 1502 may transmit CSI report 1564 reporting channel information 1566 accordingly (e.g., the predicted L1-RSRP/L1-SINR/CRI measurements associated with these time instances and Set A beams).

In one example, the reference signal resource may be associated with a CSI-RS pattern for the virtual reference signal based on the reference signal resource lacking a CSI-RS resource mapping configuration, and the channel information may be based on the CSI-RS pattern. For instance, referring to FIG. 15, configuration 1510 may not include CSI-RS resource mapping configuration 1552 (e.g., CSI-RS resource mapping configuration 1204), in which case CSI-RS pattern 1554 for virtual reference signal resource 1512 may be a pre-defined, configured, or indicated CSI-RS pattern matching one of the patterns illustrated in FIG. 6 (e.g., as described with respect to FIG. 12A). Based on this pre-defined or separately configured or indicated CSI-RS pattern, the UE 1502 may predict the channel information 1566 (e.g., signal quality) associated with virtual reference signal 1514. For example, the UE 1502 may calculate virtual RSRPs at the REs indicated in the virtual resource mapping associated with nominal CSI-RS resource (e.g., by summarizing the RSRPs predicted for the respective REs), and the UE 1502 may report the summarized virtual L1-RSRP (and/or the associated CRI) of the nominal CSI-RS resource for the base station 1504 to predict a best associated Set A beam accordingly.

In one example, the CSI-RS pattern may be pre-configured, indicated in an RRC configuration, activated in a MAC-CE, or triggered in DCI. For example, referring to FIG. 15, CSI-RS pattern 1554 for the nominal CSI-RS resource associated with a Set A beam may be configured or indicated in a message associated with CSI reporting of the nominal CSI-RS resource. This message may be, for example, an RRC-configured CSI report setting associated with CRI and/or L1-RSRP/L1-SINR reporting of the nominal CSI-RS resource, a MAC-CE activating a semi-persistent report of the CRI and/or L1-RSRP/L1-SINR of the nominal CSI-RS resource, or a DCI triggering an aperiodic report of the CRI and/or L1-RSRP/L1-SINR of the nominal CSI-RS resource.

In another example, the channel information may be based on the physical reference signal, and the CSI-RS pattern for the virtual reference signal may be identical to a second CSI-RS pattern associated with the physical reference signal. For example, referring to FIG. 15, CSI-RS pattern 1554 for the nominal CSI-RS resource (e.g., a Set A beam) may be identical to CSI-RS pattern 1556 for the physical reference signal resource 1534, which physical CSI-RS resource the UE may apply as a measurement source (e.g., a Set B beam) for deriving channel information 1566 associated with the nominal CSI-RS resource. For example, if a Set B beam is associated with one of the CSI-RS patterns 600 of FIG. 6, the set A beam may be associated with the same CSI-RS pattern.

In one example, the reference signal resource may include a CSI-RS resource mapping configuration indicating a CSI-RS pattern for the virtual reference signal, and the channel information may be based on the CSI-RS pattern. For instance, referring to FIG. 15, configuration 1510 may include CSI-RS resource mapping configuration 1552 (e.g., CSI-RS resource mapping configuration 1254), in which case CSI-RS pattern 1554 for virtual reference signal resource 1512 may be as indicated in the CSI-RS resource mapping configuration 1552 (e.g., as described with respect to FIG. 12B). The UE 1502 may determine to apply the CSI-RS pattern 1554 associated with the CSI-RS resource mapping configuration 1552 for such nominal CSI-RS resource when deriving channel information 1566 (e.g., a CRI and/or L1-RSRP/L1-SINR) associated with this resource. For example, the nominal CSI-RS resource associated with a Set A beam may be configured or indicated with one of the CSI-RS patterns 600 of FIG. 6, in which case the UE may calculate the L1-RSRP/L1-SINR and/or determine the CRI associated with this nominal CSI-RS resource based on the REs indicated in the CSI-RS pattern 1554.

In one example, the reference signal resource may be associated with beam information. For instance, referring to FIG. 15, configuration 1510 may include beam information 1558 indicating beam shapes or other parameters associated with virtual reference signal resource 1512. The beam information may include at least one of: a geographic direction of a transmission beam for the virtual reference signal; a beam width of the transmission beam; beamforming gain information associated with an angle of the transmission beam; or a beamforming coefficient associated with the virtual reference signal. For instance, referring to FIGS. 13 and 15, beam information 1558 may include a geographic direction of a transmission beam for the virtual reference signal 1514 (e.g., geographical direction 1306 associated with a boresight of a transmission beam associated with the nominal CSI-RS resource), a beam width of the transmission beam (e.g., beam width 1308, such as an X-dB beam width in an angular domain with respect to a peak beamforming gain, where X is an integer)), beamforming gain information associated with an angle of the transmission beam (e.g., beamforming gain information 1310), or a beamforming coefficient associated with the virtual reference signal (e.g., beamforming coefficient 1312, which may be digital or analog).

In one example, the beam information may be indicated in an RRC configuration, activated in a MAC-CE, or triggered in DCI. For instance, referring to FIGS. 13 and 15, in one example, the beam information 1302, 1558 may be included in an RRC configuration of nominal CSI-RS resource 1304. For instance, one of the configurations according to the examples of FIGS. 8A, 8B, 9A, or 9B may include the beam information 1302, 1558 for the nominal CSI-RS resource 1304. In another example, the beam information 1302, 1558 may be included in a MAC-CE activation command for the nominal CSI-RS resource 1304. For instance, a MAC-CE activating a nominal semi-persistent CSI-RS resource may include the beam information 1302, 1558 for the nominal CSI-RS resource 1304. In a further example, the beam information 1302, 1558 may be included in a MAC-CE activation command which activates the UE to provide a report including predicted CSI (e.g., CRI and/or L1-RSRP/L1-SINR) for the nominal CSI-RS resource 1304. For instance, a MAC-CE activating the CSI report for the nominal CSI-RS resource may include the beam information 1302, 1558 for the nominal CSI-RS resource 1304. In an additional example, the beam information 1302, 1558 may be included in a trigger configuration for an aperiodic CSI report including predicted CSI (e.g., CRI and/or L1-RSRP/L1-SINR) for the nominal CSI-RS resource 1304. For instance, a DCI triggering the CSI report for the nominal CSI-RS resource may include the beam information 1302, 1558 for the nominal CSI-RS resource 1304.

In one example, the channel information may be based on one of: the beam information; or the beam information and second beam information associated with the physical reference signal. For instance, referring to FIGS. 13 and 15, virtual reference signal resource 1512 may be associated with beam information 1302, 1558 for virtual reference signal 1514, and physical reference signal resource 1534 may be associated with beam information 1302, 1560 for physical reference signal 1528. The UE 1502 may input beam information 1302, 1558 associated with the nominal CSI-RS resource 1304 into an AI/ML model (e.g., ML model 502, 503, ML-based beam prediction model 704) to obtain channel information 1566 (e.g., a CRI and/or L1-RSRP/L1-SINR) associated with the nominal CSI-RS resource 1304 as an output from the AI/ML model. Additionally, the UE 1502 may further predict channel information 1566 (e.g., CRI and/or L1-RSRP/L1-SINR) for the nominal CSI-RS resource (e.g., associated with a Set A beam) based on the beam information 1302, 1560 associated with the physical reference signal resource 1534. For instance, in addition to inputting the beam information 1302, 1558 associated with virtual reference signal resource 1512 in its AI/ML model such as previously described, the UE 1502 may input beam information 1302, 1560 associated with a physically transmitted SSB or CSI-RS in its AI/ML model to output the predicted CRI and/or L1-RSRP/L1-SINR associated with the nominal CSI-RS resource 1304.

In one example, the channel information may be based on a physical CSI-RS associated with a physical CSI-RS resource, and a maximum quantity of supported physical CSI-RS resources or supported physical CSI-RS antenna ports may be based on the UE capability information transmitted at 1602. For instance, referring to FIG. 15, UE 1502 may predict channel information 1566 (e.g., CSI associated with a nominal CSI-RS resource associated with a Set A beam) based on the signal quality metric 1562 of physical reference signal 1528 associated with physical reference signal resource 1534 (e.g., a NZP CSI-RS resource associated with a Set B beam). Moreover, when the UE 1502 transmits UE capability information message 1506, this message may include NZP CSI-RS capability category 1404 and nominal CSI-RS capability category 1414 such as described with respect to FIG. 14, where the NZP CSI-RS capability category 1404 reported by the UE (e.g., its maximum number of configured or active CSI-RS resources and ports) takes into account the nominal CSI-RS capability category 1414 (e.g., its maximum configured or active nominal CSI-RS resources or ports). Thus, if the UE 1502 were to report that it can simultaneously activate 8 NZP CSI-RS resources in NZP CSI-RS capability category 1404 and 4 nominal CSI-RS resources in nominal CSI-RS capability category 1414, the UE may only activate 8 CSI-RS resources in total (e.g., at least four physical and at most four nominal in various combinations, such as 4 and 4; 5 and 3; 6 and 2; 7 and 1; or 8 and 0).

In one example, the channel information may be based on a physical CSI-RS associated with a physical CSI-RS resource, and a maximum quantity of supported physical CSI-RS resources or supported physical CSI-RS antenna ports may be independent of the UE capability information transmitted at 1602. For instance, referring to FIG. 15, UE 1502 may predict channel information 1566 (e.g., CSI associated with a nominal CSI-RS resource associated with a Set A beam) based on the signal quality metric 1562 of physical reference signal 1528 associated with physical reference signal resource 1534 (e.g., a NZP CSI-RS resource associated with a Set B beam). Moreover, when the UE 1502 transmits UE capability information message 1506, this message may include NZP CSI-RS capability category 1404 and nominal CSI-RS capability category 1414 such as described with respect to FIG. 14, where the NZP CSI-RS capability category 1404 reported by the UE (e.g., its maximum number of configured or active CSI-RS resources and ports) does not take into account the nominal CSI-RS capability category 1414 (e.g., its maximum configured or active nominal CSI-RS resources or ports). Thus, if the UE 1502 were to report that it can simultaneously activate 8 NZP CSI-RS resources in NZP CSI-RS capability category 1404 and 4 nominal CSI-RS resources in nominal CSI-RS capability category 1414, the UE may activate 12 CSI-RS resources in total (e.g., at most eight physical and at most four nominal in various combinations).

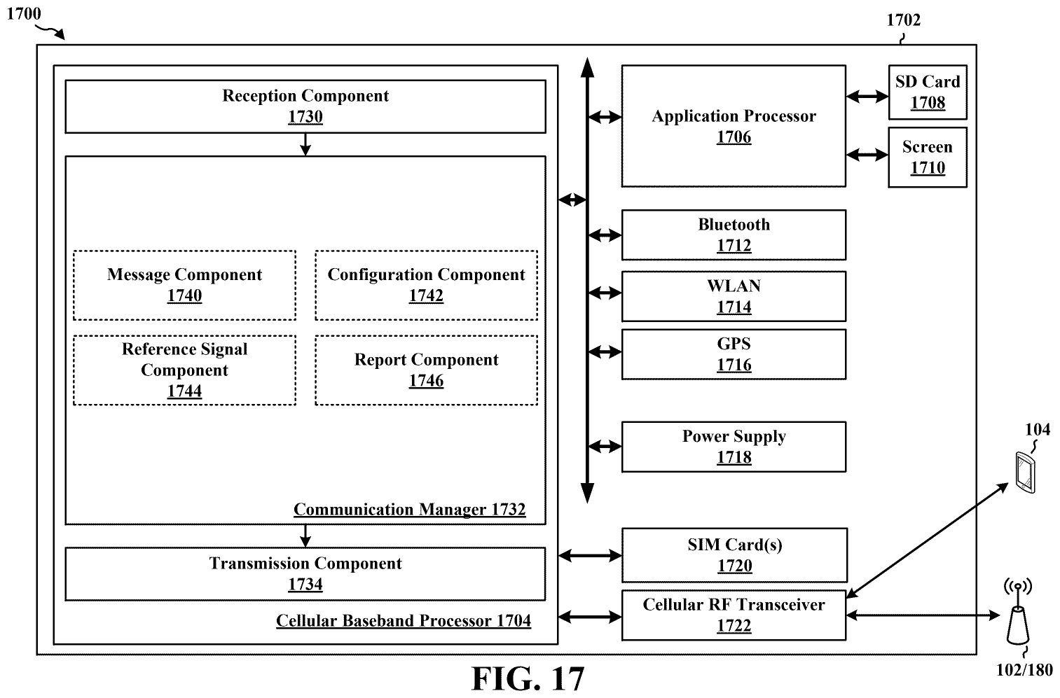

FIG. 17 is a diagram 1700 illustrating an example of a hardware implementation for an apparatus 1702. The apparatus 1702 is a UE and includes a cellular baseband processor 1704 (also referred to as a modem) coupled to a cellular RF transceiver 1722 and one or more subscriber identity modules (SIM) cards 1720, an application processor 1706 coupled to a secure digital (SD) card 1708 and a screen 1710, a Bluetooth module 1712, a wireless local area network (WLAN) module 1714, a Global Positioning System (GPS) module 1716, and a power supply 1718. The cellular baseband processor 1704 communicates through the cellular RF transceiver 1722 with the UE 104 and/or BS 102/180. The cellular baseband processor 1704 may include a computer-readable medium/memory. The computer-readable medium/memory may be non-transitory. The cellular baseband processor 1704 is responsible for general processing, including the execution of software stored on the computer-readable medium/memory. The software, when executed by the cellular baseband processor 1704, causes the cellular baseband processor 1704 to perform the various functions described supra. The computer-readable medium/memory may also be used for storing data that is manipulated by the cellular baseband processor 1704 when executing software. The cellular baseband processor 1704 further includes a reception component 1730, a communication manager 1732, and a transmission component 1734. The communication manager 1732 includes the one or more illustrated components. The components within the communication manager 1732 may be stored in the computer-readable medium/memory and/or configured as hardware within the cellular baseband processor 1704. The cellular baseband processor 1704 may be a component of the UE 350 and may include the memory 360 and/or at least one of the TX processor 368, the RX processor 356, and the controller/processor 359. In one configuration, the apparatus 1702 may be a modem chip and include just the baseband processor 1704, and in another configuration, the apparatus 1702 may be the entire UE (e.g., see 350 of FIG. 3) and include the aforediscussed additional modules of the apparatus 1702.

The communication manager 1732 includes a message component 1740 that is configured to transmit a message indicating UE capability information associated with the reference signal resource, the UE capability information including at least one of: a first maximum quantity of configured reference signal resources for a component carrier; a second maximum quantity of antenna ports across the configured reference signal resources; a third maximum quantity of simultaneous reference signal resources for the component carrier; or a total quantity of the antenna ports in the simultaneous reference signal resources, e.g., as described in connection with 1602. For instance, the controller/processor 359 or the TX processor 368 of UE 104, 350, 1502 may include message component 1740, which may transmit the message to the base station 102/180, 310, 1504 by, for example, mapping coded and modulated symbols of the message to a spatial stream, modulating an RF carrier with the spatial stream, and providing the modulated RF carrier to the base station via antennas 352.

The communication manager 1732 further includes a configuration component 1742 that is configured to receive a configuration of a reference signal resource for a virtual reference signal that does not occupy a physical resource, e.g., as described in connection with 1604. For instance, the controller/processor 359 or the RX processor 356 of UE 104, 350, 1502 may include configuration component 1742, which may receive the configuration from the base station 102/180, 310, 1504 by, for example, obtaining via antennas 352 a modulated RF carrier including mapped coded and modulated symbols of the configuration in a spatial stream, demodulating the spatial stream from the RF carrier, and de-mapping the coded and modulated symbols of the configuration from the demodulated spatial stream.

The communication manager 1732 further includes a reference signal component 1744 that is configured to receive a physical reference signal, wherein the physical reference signal is a SSB or a CSI-RS, e.g., as described in connection with 1606. For instance, the controller/processor 359 or the RX processor 356 of UE 104, 350, 1502 may include reference signal component 1744, which may receive the reference signal from the base station 102/180, 310, 1504 by, for example, obtaining via antennas 352 a modulated RF carrier including mapped coded and modulated symbols of the reference signal in a spatial stream, demodulating the spatial stream from the RF carrier, and de-mapping the coded and modulated symbols of the reference signal from the demodulated spatial stream.

The communication manager 1732 further includes a report component 1746 that is configured to transmit a report indicating channel information associated with the reference signal resource, e.g., as described in connection with 1608. For instance, the controller/processor 359 or the TX processor 368 of UE 104, 350, 1502 may include report component 1746, which may transmit the report to the base station 102/180, 310, 1504 by, for example, mapping coded and modulated symbols of the report to a spatial stream, modulating an RF carrier with the spatial stream, and providing the modulated RF carrier to the base station via antennas 352.

The apparatus may include additional components that perform each of the blocks of the algorithm in the aforementioned flowchart of FIG. 16. As such, each block in the aforementioned flowchart of FIG. 16 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

In one configuration, the apparatus 1702, and in particular the cellular baseband processor 1704, includes means for receiving a configuration of a reference signal resource for a virtual reference signal that does not occupy a physical resource; and means for transmitting a report indicating channel information associated with the reference signal resource.

In one configuration, the means for receiving may be further configured to receive a physical reference signal, wherein the physical reference signal is a SSB or a CSI-RS, and the channel information is based on the physical reference signal.

In one configuration, the means for transmitting may be further configured to transmit a message indicating UE capability information associated with the reference signal resource, the UE capability information including at least one of: a first maximum quantity of configured reference signal resources for a component carrier; a second maximum quantity of antenna ports across the configured reference signal resources; a third maximum quantity of simultaneous reference signal resources for the component carrier; or a total quantity of the antenna ports in the simultaneous reference signal resources.

The aforementioned means may be one or more of the aforementioned components of the apparatus 1702 configured to perform the functions recited by the aforementioned means. As described supra, the apparatus 1702 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

Accordingly, aspects of the present disclosure allow a UE to be configured with nominal CSI resources which provide virtual references for the UE to report channel information for one set of predicted transmission beams (e.g., Set A beams) based on measurement results of another set of physical transmission beams (e.g., Set B beams). A configuration mechanism for nominal CSI-RS resources associated with target beams (e.g., Set A beams) may be provided to better support beam prediction in the spatial domain or the spatial and temporal domain. Likewise, the UE may identify appropriate CSI-RS patterns and beam shape information for such nominal CSI-RS resources to better support prediction of such resources' CSI. Furthermore, since the UE hardware or software that may be required to process nominal CSI-RS resources and ports may be different than those required for processing physical CSI-RS resources and ports, additional UE capability signaling may be provided for the UE to indicate its supported, maximum number of configured or active nominal CSI-RS resources or ports. As a result, beam management operations based on AI/ML-based beam prediction or selection may be improved over conventional beam prediction approaches, since the nominal CSI-RS resource configurations allow the UE to measure signals in less transmission beams, to switch between fewer reception beams in determining a best beam pair, and to receive less physical reference signals in wireless communication, thereby allowing the UE to save power consumption, experience reduced latency, and communicate with reduced overhead.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Terms such as “if,” “when,” and “while” should be interpreted to mean “under the condition that” rather than imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

The following examples are illustrative only and may be combined with aspects of other embodiments or teachings described herein, without limitation.

Example 1 is an apparatus for wireless communication, including: a processor; memory coupled with the processor; and instructions stored in the memory and operable, when executed by the processor, to cause the apparatus to: receive a configuration of a reference signal resource for a virtual reference signal that does not occupy a physical resource; and transmit a report indicating channel information associated with the reference signal resource.

Example 2 is the apparatus of Example 1, wherein the channel information includes at least one of: a channel state information (CSI) reference signal (CSI-RS) resource indicator (CRI) associated with the reference signal resource; or a signal quality metric associated with the reference signal resource.

Example 3 is the apparatus of Examples 1 or 2, wherein the instructions, when executed by the processor, further cause the apparatus to: receive a physical reference signal, wherein the physical reference signal is a synchronization signal block (SSB) or a channel state information (CSI) reference signal (CSI-RS), and the channel information is based on the physical reference signal.

Example 4 is the apparatus of Example 3, wherein a signal quality metric of the physical reference signal is an input of a machine learning (ML) model of the apparatus, and the channel information associated with the reference signal resource is based on an output of the ML model.

Example 5 is the apparatus of any of Examples 1 to 4, wherein the reference signal resource is a periodic channel state information (CSI) reference signal (CSI-RS) resource indicated in a radio resource control (RRC) configuration, a semi-persistent CSI-RS resource activated in a medium access control (MAC) control element (MAC-CE), or an aperiodic CSI-RS resource triggered in downlink control information.

Example 6 is the apparatus of any of Examples 1 to 5, wherein the configuration includes a plurality of different types of channel state information (CSI) reference signal (CSI-RS) resources, a first one of the different types being the reference signal resource, and a second one of the different types being a non-zero power (NZP) CSI-RS resource or a zero power (ZP) CSI-RS resource.

Example 7 is the apparatus of Example 6, wherein the configuration is a CSI measurement configuration, and the second one of the different types is the NZP CSI-RS resource.

Example 8 is the apparatus of Example 6, wherein the configuration is a physical downlink control channel (PDSCH) configuration, and the second one of the different types is the ZP CSI-RS resource.

Example 9 is the apparatus of any of Examples 1 to 5, wherein the reference signal resource is a non-zero power (NZP) CSI-RS resource or a zero power (ZP) CSI-RS resource, the reference signal resource further including a parameter indicating that the virtual reference signal does not occupy the physical resource.

Example 10 is the apparatus of any of Examples 1 to 9, wherein the configuration is received based on a capability of the apparatus to predict a transmission beam based on the virtual reference signal.

Example 11 is the apparatus of any of Examples 1 to 10, wherein the virtual reference signal is mapped to a slot associated with a physical reference signal based on the reference signal resource lacking periodicity and offset information for the virtual reference signal.

Example 12 is the apparatus of any of Examples 1 to 10, wherein the reference signal resource includes periodicity and offset information for the virtual reference signal, and the virtual reference signal is mapped to a slot associated with a physical reference signal based on the periodicity and offset information.

Example 13 is the apparatus of any of Examples 1 to 12, wherein the reference signal resource includes an indication that a physical reference signal is quasi co-located (QCL) with the virtual reference signal, and the virtual reference signal is mapped to a slot associated with the physical reference signal based on the indication.

Example 14 is the apparatus of any of Examples 1 to 13, wherein the reference signal resource includes an indication that the reference signal resource is associated with beam prediction in a spatial domain, and the virtual reference signal is mapped to a slot associated with a physical reference signal based on the indication.

Example 15 is the apparatus of any of Examples 1 to 14, wherein the channel information is transmitted in a channel state information (CSI) report associated with a plurality of time instances for transmission beam prediction, and the virtual reference signal is mapped to each of the time instances based on the reference signal resource lacking periodicity and offset information for the virtual reference signal, the time instances being indicated in a radio resource control (RRC) configuration, activated in a medium access control (MAC) control element (MAC-CE), or triggered in downlink control information (DCI).

Example 16 is the apparatus of any of Examples 1 to 14, wherein the channel information is transmitted in a channel state information (CSI) report associated with a plurality of time instances for transmission beam prediction, the reference signal resource includes periodicity and offset information for the virtual reference signal, and the virtual reference signal is mapped to each of the time instances based on the periodicity and offset information, the time instances being indicated in a radio resource control (RRC) configuration, activated in a medium access control (MAC) control element (MAC-CE), or triggered in downlink control information (DCI).

Example 17 is the apparatus of any of Examples 1 to 16, wherein the channel information is transmitted in a channel state information (CSI) report associated with a plurality of time instances for transmission beam prediction, the reference signal resource includes an indication that the reference signal resource is associated with the transmission beam prediction in a temporal domain, and the virtual reference signal is mapped to each of the time instances based on the indication.

Example 18 is the apparatus of any of Examples 1 to 17, wherein the reference signal resource is associated with a channel state information (CSI) reference signal (CSI-RS) pattern for the virtual reference signal based on the reference signal resource lacking a CSI-RS resource mapping configuration, the channel information being based on the CSI-RS pattern.

Example 19 is the apparatus of Example 18, wherein the CSI-RS pattern is pre-configured, indicated in a radio resource control (RRC) configuration, activated in a medium access control (MAC) control element (MAC-CE), or triggered in downlink control information (DCI).

Example 20 is the apparatus of Examples 18 or 19, wherein the channel information is based on a physical reference signal, and the CSI-RS pattern for the virtual reference signal is identical to a second CSI-RS pattern associated with the physical reference signal.

Example 21 is the apparatus of any of Examples 1 to 17, wherein the reference signal resource includes a channel state information (CSI) reference signal (CSI-RS) resource mapping configuration indicating a CSI-RS pattern for the virtual reference signal, the channel information being based on the CSI-RS pattern.

Example 22 is the apparatus of any of Examples 1 to 21, wherein the reference signal resource is associated with beam information, the beam information being indicated in a radio resource control (RRC) configuration, activated in a medium access control (MAC) control element (MAC-CE), or triggered in downlink control information (DCI).

Example 23 is the apparatus of Example 22, wherein the beam information includes at least one of: a geographic direction of a transmission beam for the virtual reference signal; a beam width of the transmission beam; beamforming gain information associated with an angle of the transmission beam; or a beamforming coefficient associated with the virtual reference signal.

Example 24 is the apparatus of Examples 22 or 23, wherein the channel information is based on one of: the beam information; or the beam information and second beam information associated with a physical reference signal.

Example 25 is the apparatus of any of Examples 1 to 24, wherein the instructions when executed by the processor, further cause the apparatus to: transmit a message indicating user equipment (UE) capability information associated with the reference signal resource, the UE capability information including at least one of: a first maximum quantity of configured reference signal resources for a component carrier; a second maximum quantity of antenna ports across the configured reference signal resources; a third maximum quantity of simultaneous reference signal resources for the component carrier; or a total quantity of the antenna ports in the simultaneous reference signal resources.

Example 26 is the apparatus of Example 25, wherein the channel information is based on a physical channel state information (CSI) reference signal (CSI-RS) associated with a physical CSI-RS resource, and a maximum quantity of supported physical CSI-RS resources or supported physical CSI-RS antenna ports is based on the UE capability information.

Example 27 is the apparatus of Example 25, wherein the channel information is based on a physical channel state information (CSI) reference signal (CSI-RS) associated with a physical CSI-RS resource, and a maximum quantity of supported physical CSI-RS resources or supported physical CSI-RS antenna ports is independent of the UE capability information.

Example 28 is a method of wireless communication at a user equipment (UE), including: receiving a configuration of a reference signal resource for a virtual reference signal that does not occupy a physical resource; and transmitting a report indicating channel information associated with the reference signal resource.

Example 29 is an apparatus for wireless communication, including: means for receiving a configuration of a reference signal resource for a virtual reference signal that does not occupy a physical resource; and means for transmitting a report indicating channel information associated with the reference signal resource.

Example 30 is a non-transitory, computer-readable medium storing computer executable code, the code when executed by a processor cause the processor to: receive a configuration of a reference signal resource for a virtual reference signal that does not occupy a physical resource; and transmit a report indicating channel information associated with the reference signal resource.

What is claimed is:

1. An apparatus for wireless communication, comprising:
a processor;
memory coupled with the processor; and
instructions stored in the memory and operable, when executed by the processor, to cause the apparatus to:
receive a configuration of a reference signal resource for a virtual reference signal that does not occupy a physical resource; and
transmit a report indicating channel information associated with the reference signal resource.

2. The apparatus of claim 1, wherein the channel information includes at least one of:
a channel state information (CSI) reference signal (CSI-RS) resource indicator (CRI) associated with the reference signal resource; or
a signal quality metric associated with the reference signal resource.

3. The apparatus of claim 1, wherein the instructions, when executed by the processor, further cause the apparatus to:
receive a physical reference signal, wherein the physical reference signal is a synchronization signal block (SSB) or a channel state information (CSI) reference signal (CSI-RS), and the channel information is based on the physical reference signal.

4. The apparatus of claim 3, wherein a signal quality metric of the physical reference signal is an input of a machine learning (ML) model of the apparatus, and the channel information associated with the reference signal resource is based on an output of the ML model.

5. The apparatus of claim 1, wherein the reference signal resource is a periodic channel state information (CSI) reference signal (CSI-RS) resource indicated in a radio resource control (RRC) configuration, a semi-persistent CSI-RS resource activated in a medium access control (MAC) control element (MAC-CE), or an aperiodic CSI-RS resource triggered in downlink control information.

6. The apparatus of claim 1, wherein the configuration includes a plurality of different types of channel state information (CSI) reference signal (CSI-RS) resources, a first one of the different types being the reference signal resource, and a second one of the different types being a non-zero power (NZP) CSI-RS resource or a zero power (ZP) CSI-RS resource.

7. The apparatus of claim 6, wherein the configuration is a CSI measurement configuration, and the second one of the different types is the NZP CSI-RS resource.

8. The apparatus of claim 6, wherein the configuration is a physical downlink control channel (PDSCH) configuration, and the second one of the different types is the ZP CSI-RS resource.

9. The apparatus of claim 1, wherein the reference signal resource is a non-zero power (NZP) CSI-RS resource or a zero power (ZP) CSI-RS resource, the reference signal resource further including a parameter indicating that the virtual reference signal does not occupy the physical resource.

10. The apparatus of claim 1, wherein the configuration is received based on a capability of the apparatus to predict a transmission beam based on the virtual reference signal.

11. The apparatus of claim 1, wherein the virtual reference signal is mapped to a slot associated with a physical reference signal based on the reference signal resource lacking periodicity and offset information for the virtual reference signal.

12. The apparatus of claim 1, wherein the reference signal resource includes periodicity and offset information for the virtual reference signal, and the virtual reference signal is mapped to a slot associated with a physical reference signal based on the periodicity and offset information.

13. The apparatus of claim 1, wherein the reference signal resource includes an indication that a physical reference signal is quasi co-located (QCL) with the virtual reference signal, and the virtual reference signal is mapped to a slot associated with the physical reference signal based on the indication.

14. The apparatus of claim 1, wherein the reference signal resource includes an indication that the reference signal resource is associated with beam prediction in a spatial domain, and the virtual reference signal is mapped to a slot associated with a physical reference signal based on the indication.

15. The apparatus of claim 1, wherein the channel information is transmitted in a channel state information (CSI) report associated with a plurality of time instances for transmission beam prediction, and the virtual reference signal is mapped to each of the time instances based on the reference signal resource lacking periodicity and offset information for the virtual reference signal, the time instances being indicated in a radio resource control (RRC) configuration, activated in a medium access control (MAC) control element (MAC-CE), or triggered in downlink control information (DCI).

16. The apparatus of claim 1, wherein the channel information is transmitted in a channel state information (CSI) report associated with a plurality of time instances for transmission beam prediction, the reference signal resource includes periodicity and offset information for the virtual reference signal, and the virtual reference signal is mapped to each of the time instances based on the periodicity and offset information, the time instances being indicated in a radio resource control (RRC) configuration, activated in a medium access control (MAC) control element (MAC-CE), or triggered in downlink control information (DCI).

17. The apparatus of claim 1, wherein the channel information is transmitted in a channel state information (CSI) report associated with a plurality of time instances for transmission beam prediction, the reference signal resource includes an indication that the reference signal resource is associated with the transmission beam prediction in a temporal domain, and the virtual reference signal is mapped to each of the time instances based on the indication.

18. The apparatus of claim 1, wherein the reference signal resource is associated with a channel state information (CSI) reference signal (CSI-RS) pattern for the virtual reference signal based on the reference signal resource lacking a CSI-RS resource mapping configuration, the channel information being based on the CSI-RS pattern.

19. The apparatus of claim 18, wherein the CSI-RS pattern is pre-configured, indicated in a radio resource control (RRC) configuration, activated in a medium access control (MAC) control element (MAC-CE), or triggered in downlink control information (DCI).

20. The apparatus of claim 18, wherein the channel information is based on a physical reference signal, and the CSI-RS pattern for the virtual reference signal is identical to a second CSI-RS pattern associated with the physical reference signal.

21. The apparatus of claim 1, wherein the reference signal resource includes a channel state information (CSI) reference signal (CSI-RS) resource mapping configuration indicating a CSI-RS pattern for the virtual reference signal, the channel information being based on the CSI-RS pattern.

22. The apparatus of claim 1, wherein the reference signal resource is associated with beam information, the beam information being indicated in a radio resource control (RRC) configuration, activated in a medium access control (MAC) control element (MAC-CE), or triggered in downlink control information (DCI).

23. The apparatus of claim 22, wherein the beam information includes at least one of:
a geographic direction of a transmission beam for the virtual reference signal;
a beam width of the transmission beam;
beamforming gain information associated with an angle of the transmission beam; or
a beamforming coefficient associated with the virtual reference signal.

24. The apparatus of claim 22, wherein the channel information is based on one of:
the beam information; or
the beam information and second beam information associated with a physical reference signal.

25. The apparatus of claim 1, wherein the instructions when executed by the processor, further cause the apparatus to:
transmit a message indicating user equipment (UE) capability information associated with the reference signal resource, the UE capability information including at least one of:
a first maximum quantity of configured reference signal resources for a component carrier;
a second maximum quantity of antenna ports across the configured reference signal resources;
a third maximum quantity of simultaneous reference signal resources for the component carrier; or
a total quantity of the antenna ports in the simultaneous reference signal resources.

26. The apparatus of claim 25, wherein the channel information is based on a physical channel state information (CSI) reference signal (CSI-RS) associated with a physical CSI-RS resource, and a maximum quantity of supported physical CSI-RS resources or supported physical CSI-RS antenna ports is based on the UE capability information.

27. The apparatus of claim 25, wherein the channel information is based on a physical channel state information (CSI) reference signal (CSI-RS) associated with a physical CSI-RS resource, and a maximum quantity of supported physical CSI-RS resources or supported physical CSI-RS antenna ports is independent of the UE capability information.

28. A method of wireless communication at a user equipment (UE), comprising:
receiving a configuration of a reference signal resource for a virtual reference signal that does not occupy a physical resource; and
transmitting a report indicating channel information associated with the reference signal resource.

29. An apparatus for wireless communication, comprising:
means for receiving a configuration of a reference signal resource for a virtual reference signal that does not occupy a physical resource; and
means for transmitting a report indicating channel information associated with the reference signal resource.

30. A non-transitory, computer-readable medium storing computer executable code, the code when executed by a processor cause the processor to:
receive a configuration of a reference signal resource for a virtual reference signal that does not occupy a physical resource; and
transmit a report indicating channel information associated with the reference signal resource.
